(19) United States
(12) Patent Application Publication
(10) Pub. No.: US 2026/0212204 A1
(43) Pub. Date: Jul. 23, 2026

(54) USING MULTIMODAL LARGE LANGUAGE MODELS TO CONVERT UNIFIED MODELING LANGUAGE IMAGES TO CODE

(71) Applicant: The Board of Regents of the University of Oklahoma, Norman, OK (US)

(72) Inventors: Chongle Pan, Norman, OK (US); Averi J. Bates, Edmond, OK (US); Shane Carleton, Union Grove, AL (US)

(21) Appl. No.: 19/423,819

(22) Filed: Dec. 17, 2025

Related U.S. Application Data
(60) Provisional application No. 63/736,062, filed on Dec. 19, 2024.
(60) Provisional application No. 63/776,635, filed on Mar. 24, 2025.

(51) Int. Cl. G06N 3/096

(52) U.S. Cl. CPC G06N 3/096

(57) ABSTRACT

Systems and methods include a system comprising a processor and a memory storing processor-executable instructions that when executed cause the processor to implement a multimodal large language model (MM-LLM) comprising a vision encoder, a vision-language connector, and a language model. The processor implementing the MM-LLM receives a multimodal prompt comprising a visual input depicting an input diagram generated using an input code segment comprising input unified modeling language (UML) code and a textual input identifying an input diagram type, processes the visual input with the vision encoder to generate visual embedding vectors in a first dimensional space, processes the textual input with the language model to generate textual embedding vectors in a second dimensional space, projects the visual embedding vectors into the second dimensional space, and processes the visual and textual embedding vectors in the second dimensional space to generate an output code segment comprising output UML code.

### CROSS-REFERENCE TO RELATED APPLICATIONS

This application claims priority to the provisional patent applications identified by U.S. Ser. No. 63/736,062, filed Dec. 19, 2024, and U.S. Ser. No. 63/776,635, filed Mar. 24, 2025, the entire content of which are hereby expressly incorporated herein by reference.

### ACKNOWLEDGMENT OF GOVERNMENT SUPPORT

This invention was made with government support under Contract Number FA864924P0873 awarded by the Department of Defense. The government has certain rights in the invention.

### BACKGROUND

In software engineering, the Unified Modeling Language (UML) is a widely used tool for visually representing and analyzing complex systems. UML provides a standardized approach to documenting, designing, and refining software solutions. It supports various stages of the development lifecycle by structuring software design, clarifying relationships, and encouraging stakeholder communication. UML carries substantial educational value as educators incorporate it into their curricula to improve student abilities in structuring and visualizing software architecture. Proficiency in UML has been compared to an architect's use of blueprints, underscoring the importance of systematic and organized design frameworks. Since its formal adoption in 1997, UML has evolved into a de facto standard; its general-purpose and customizable language allows it to use projects across various industries.

Various methodologies have been created to augment and/or enhance UML by incorporating frameworks like the Create, Read, Update, Delete (CRUD) matrix and axiomatic design. The CRUD matrix, for instance, brings clarity by mapping out fundamental data operations, which helps pinpoint data flow inefficiencies and sheds light on interactions among system components. The CRUD approach is valuable in systems with complex databases or extensive user interactions, where streamlined data handling is crucial. On the other hand, axiomatic design offers a strategy for building systems that fulfill functional requirements while minimizing unnecessary complexity. When combined with UML, the axiomatic design fosters a holistic approach, ensuring systems are functionally robust and easier to understand and maintain, providing a particularly effective strategy for layered architectures, where balancing high-level overviews with specific functional details to preserve design integrity.

UML remains an indispensable tool in software engineering, with or without enhancement, though it often faces usability constraints. UML diagrams are frequently stored in fixed formats like images or pdfs, making the UML diagrams challenging to adapt in automated workflows and complicating direct code generation. Such fixed formats can hinder design verification and consistency checks in development environments that prioritize flexibility. Without editable diagrams, developers cannot update or interact with designs in real-time, complicating iterative processes fundamental to continuous integration. This manual update requirement also introduces time-consuming tasks and heightens the risk of human error, especially in large, complex systems.

These limitations are even more pronounced when working with legacy systems or external documentation, where diagrams may not align with current design standards. Converting these diagrams into functional code often requires expertise from both the original and target systems. This manual process can slow development and introduce discrepancies between the design documentation and the final system, where small oversights can lead to issues with functionality, maintainability, or security. Consequently, automated tools for converting UML diagrams into editable, up-to-date code are desirable.

Manual translation remains labor-intensive and inconsistent between the documented design and the implemented system. As developers analyze complex structures and connections, minor discrepancies can accumulate, causing issues in later development stages. An automated method to convert UML diagrams directly into editable code would significantly streamline development, reducing the potential for human error. As software systems grow in complexity, the demand for such automated conversion tools is becoming urgent. Tools capable of interpreting static diagrams and translating the static diagrams into functional, editable code are desirable for modern workflows to use UML fully. Recent research actively explores methods to extract elements from visuals, bridging the gap between design documentation and agile, iterative development environment.

Existing tools that translate between UML diagrams and code, such as traditional modeling software and early rule-based systems, have been available for a long time. However, these tools often rely on static, rule-based methods that require extensive manual configuration and are limited in flexibility. The existing tools typically lack adaptability when dealing with non-standard or complex UML diagrams, and the existing tools may struggle with subtle variations across different types of diagrams, making the existing tools less effective for handling intricate or large-scale projects. Multimodal Large Language Models (MM-LLMs) combine advanced machine learning techniques with multimodal processing capabilities. MM-LLMs use deep learning-based vision and language integration to go beyond basic rule-based or heuristic approaches. The multimodal approach's ability to process both visual and textual inputs allows it to extract richer semantic information from UML images, resulting in a more nuanced understanding of complex diagram components such as class relationships, dependencies, and hierarchical structures. Automated code generation from visual representations has gained substantial momentum.

One of the works in GUI-based code generation is pix2code: Generating Code from a Graphical User Interface Screenshot (T. Beltramelli, in Proceedings of the ACM SIGCHI symposium on engineering interactive computing systems, pp. 1-6, 2018), which demonstrates the conversion of GUI screenshots into executable code across platforms such as iOS, Android, and the web. Using CNNs and LSTM networks, this model achieved an accuracy rate of over 77%. Directly applying CNNs to pixel data for feature extraction and a domain-specific language for GUI layout representation, pix2code bypasses complex engineered heuristics, demonstrating cross-platform code generation by interpreting GUI elements directly from images.

Building on this approach, the model of Cai, Luo, and Feng integrates traditional image processing with CNN-based target detection for GUI component localization (B. Cai, J. Luo, and Z. Feng, “A novel code generator for graphical user interfaces,” Scientific Reports, vol. 13, 2023). Their model, GUICG, enhances component detection accuracy and reduces bounding box errors, achieving an F1 score of 54.3% in component detection on the RICO dataset of over 10,000 GUI images, 2% higher than the current state-of-the-art approaches. Combining image processing and deep learning methods improves detection and classification across complex visual contexts, underscoring the potential for hybrid models in enhancing visual-to-code tasks across diverse platforms.

Beyond GUIs, another relevant work explores code generation from freehand sketches by combining CNNs with program synthesis techniques (K. Ellis, D. Ritchie, A. Solar-Lezama, and J. Tenenbaum, “Learning to infer graphics programs from hand-drawn images,” Advances in neural information processing systems, vol. 31, 2018). This approach uses a two-stage model first to identify geometric primitives, then apply program synthesis to construct a structured code representation in a simplified LaTeX format. Focusing on high-level geometric structures like loops and conditional statements allows the model to achieve results in converting hand-drawn graphics into code. Such work established real-world research focuses and applications in the field.

Researchers have started developing models to extract elements from UML diagrams stored in non-editable formats. ReSECDI identifies core elements like classes and relationships within UML images, extracting structural and semantic features across varying formats and resolutions (F. Chen, L. Zhang, X. Lian, and N. Niu, “Automatically recognizing the semantic elements from UML class diagram images,” Journal of Systems and Software, vol. 193, p. 111431, 2022). However, Conrardy and Cabot observed that while ReSECDI provides robust syntactic extraction, ReSECDI does not achieve executable code generation, highlighting the limitations of current methods in advancing from diagram interpretation to functional code production (A. Conrardy and J. Cabot, “From Image to UML: First Results of Image Based UML Diagram Generation Using LLMs,” 2024). Machine learning techniques can bridge the gaps.

Transition from Large Language Models to Multimodal Large Language Models

Large Language Models (LLMs), such as BERT, GPT, and T5, have significantly advanced in tasks like text summarization, question-answering, and code generation. LLM uses deep transformer architectures to process large volumes of textual data, enabling the LLM to produce contextually rich responses. Despite LLMs capabilities, LLMs are limited to handling text, restricting LLMs applicability for multimodal data like image interpretation or auditory processing. To overcome these limitations, researchers have developed MM-LLMs, which integrate visual, auditory, and textual modalities, enabling applications that require complex, multimodal data processing.

MM-LLMs are used in Visual Question-Answering (VQA), image captioning, and cross-modal reasoning. VQA requires models to interpret visual content and answer related questions. Numerous research areas need text and image understanding: autonomous driving, healthcare diagnostics, and multimedia creation. MM-LLMs build upon the foundations of LLMs by integrating vision encoders and alignment modules, which map visual and textual features into a unified semantic space. Recent architectures like Contrastive Language-Image Pretraining (CLIP)-based vision transformers and various diffusion models allow MM-LLMs to process high-dimensional visual representations with text. The recent architectures employ adapters, like Q-Formers, to connect the visual and linguistic domains through cross-attention mechanisms.

Training MM-LLMs is a two-stage process. Training starts with the alignment of text and visual embeddings followed by fine-tuning for specific multimodal tasks. Commonly, contrastive learning is applied to align these embeddings on large, paired datasets, facilitating cross-modal understanding across various tasks. CLIP and DALL-E use multimodal datasets to establish representation alignment, allowing for image generation and video synthesis. CLIP is a neural network trained on image-text pairs. It learns from the shared representation of the pair, allowing it to understand the relationship between visual and textual information. The model can take an image and predict the most relevant text snippet, or vice versa, by learning associations between visual and linguistic cues. However, training MM-LLMs requires high computational resources, and ensuring precise cross-modal alignment has remained an ongoing research challenge. Moreover, the computational demands of handling large multimodal datasets add another layer of complexity to the training process.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a block diagram of an exemplary embodiment of an MM-LLM constructed in accordance with the present disclosure;

FIG. 2 is a block diagram of another exemplary embodiment of an MM-LLM constructed in accordance with the present disclosure, wherein the MM-LLM is a large language and vision assistant (LLaVA)-based MM-LLM;

FIG. 3 is a block diagram of another exemplary embodiment of an MM-LLM constructed in accordance with the present disclosure, wherein the MM-LLM is a LLaVA-1.5-based MM-LLM;

FIG. 4 is an exemplary embodiment of a generated sequence diagram constructed in accordance with the present disclosure;

FIG. 5 is an exemplary embodiment of a generated activity diagram constructed in accordance with the present disclosure;

FIG. 6A is an exemplary embodiment of a ground truth diagram constructed in accordance with the present disclosure;

FIG. 6B is an exemplary embodiment of an output diagram constructed in accordance with the present disclosure;

FIG. 7A is another exemplary embodiment of a ground truth diagram constructed in accordance with the present disclosure;

FIG. 7B is another exemplary embodiment of an output diagram constructed in accordance with the present disclosure;

FIG. 8 is an exemplary embodiment of a line graph constructed in accordance with the present disclosure, showing evaluation time across various model configurations and dataset conditions and the computational efficiency of different setups;

FIG. 9A is an exemplary embodiment of a bar graph constructed in accordance with the present disclosure, showing model performance on a small activity dataset, wherein results are grouped by model type and size, and showing a BLEU score and an SSIM score for each group;

FIG. 9B is another exemplary embodiment of a bar graph constructed in accordance with the present disclosure, showing model performance on a small sequence dataset, wherein results are grouped by model type and size, and showing a BLEU score and an SSIM score for each group;

FIG. 10A is another exemplary embodiment of a bar graph constructed in accordance with the present disclosure, showing model performance on a medium activity dataset, wherein results are grouped by model type and size, and showing a BLEU score and an SSIM score for each group;

FIG. 10B is another exemplary embodiment of a bar graph constructed in accordance with the present disclosure, showing model performance on a medium sequence dataset, wherein results are grouped by model type and size, and showing a BLEU score and an SSIM score for each group;

FIG. 11A is another exemplary embodiment of a bar graph constructed in accordance with the present disclosure, showing model performance on a large activity dataset, wherein results are grouped by model type and size, and showing a BLEU score and an SSIM score for each group;

FIG. 11B is another exemplary embodiment of a bar graph constructed in accordance with the present disclosure, showing model performance on a large sequence dataset, wherein results are grouped by model type and size, and showing a BLEU score and an SSIM score for each group;

FIG. 12 is another exemplary embodiment of a bar graph constructed in accordance with the present disclosure, showing model performance on an extra-large activity dataset and an extra-large sequence dataset, wherein results are grouped by model type and size, and showing a BLEU score and an SSIM score for each group;

FIG. 13A is an exemplary embodiment of a heatmap constructed in accordance with the present disclosure, wherein the heatmap shows syntax error rates for a sequence dataset;

FIG. 13B is another exemplary embodiment of a heatmap constructed in accordance with the present disclosure, wherein the heatmap shows syntax error rates for an activity dataset;

FIG. 14 is a block diagram of an exemplary embodiment of a computer system constructed in accordance with the present disclosure;

FIG. 15 is a process flow diagram of an exemplary embodiment of a method of fine-tuning an MM-LLM in accordance with the present disclosure;

FIG. 16 is a process flow diagram of an exemplary embodiment of a method of using an MM-LLM in accordance with the present disclosure; and

FIG. 17 is a screenshot of an exemplary embodiment of a user interface constructed in accordance with the present disclosure.

### DETAILED DESCRIPTION

The technical problem of adapting UML diagrams stored in fixed and/or image-based formats in automated workflows and generating functional executable code directly from such UML diagrams are solved by a method and system described herein for generating executable code from images of UML diagrams using an MM-LLM. More particularly, the disclosure is directed to a system and method for automating the generation of executable code from UML diagrams stored in image-based formats, wherein the system utilizes an MM-LLM capable of processing both visual and textual inputs.

The UML diagrams may include highly complex and non-standard diagrams, such as (1) Low-resolution diagrams, (2) hand-drawn or partially incomplete diagrams, or (3) highly intricate or dense diagrams containing multiple relationships and components.

The disclosure in certain embodiments is directed to a system and method for fine-tuning MM-LLMs to accurately translate UML diagrams into executable code, comprising (1) training the model using synthetically generated datasets representative of UML diagrams, and (2) implementing methods to optimize model efficiency and reduce computational overhead, like Low-Rank Adaptation (LoRA). The fine-tuned model is adaptable to any UML diagram type, including but not limited to, (1) activity diagrams, (2) sequence diagrams, (3) class diagrams, (4) use case diagrams, (5) component diagrams, and (6) state machine diagrams.

The disclosure in certain embodiments is directed to a system and method for improving the accuracy and fidelity of generated code from UML diagrams, the method comprising: (1) extracting structural and semantic components from the UML diagram using the MM-LLM; and (2) ensuring syntactic and logical fidelity of the generated code by evaluating the generated code with a customized metric, wherein the customized metric is selected from (1) Bilingual Evaluation Understudy (BLEU) scores for textual accuracy and (2) a Structural Similarity Index Measure (SSIM) for preserving diagrammatic relationships.

The disclosed system and method may further comprise an automated error analysis module that identifies and classifies errors in the generated code, wherein the errors may be selected from (1) syntactical errors, (2) structural mismatches between the UML diagram and generated code, and (3) contextual misinterpretations of complex relationships or interactions.

The disclosed system and method may further comprise a workflow for legacy UML diagram recovery, wherein the workflow comprises (1) receiving UML diagrams in fixed formats such as images or PDFs, and (2) processing the diagrams using the multimodal large language model to (a) extract editable UML elements, and (b) generate functional, machine-readable code representations.

In the disclosed system and method, the MM-LLM may comprise integration of (1) a vision encoder for extracting semantic features from UML diagrams, (2) a language model for generating structured textual representations corresponding to executable code, and/or (3) a vision-language connector that aligns extracted visual data with textual outputs.

In a particular embodiment, any of the disclosed systems and methods may comprise automating the translation of any UML diagram type into a syntactically correct and executable code by using a fine-tuned MM-LLM trained with at least one synthetic dataset, and wherein the syntactically correct and executable code is optimized. The syntactically correct and executable code may be optimized using LoRA. The UML diagram type may comprise a highly complex diagram and/or a non-standard diagram.

In a first aspect, the present disclosure includes a system, comprising: a processor; and a non-transitory processor-readable medium storing processor-executable instructions that when executed by the processor cause the processor to implement a multimodal large language model (MM-LLM), the MM-LLM comprising a vision encoder, a vision-language connector, and a language model, the MM-LLM having been pre-trained using visual instruction tuning to learn alignments between visual data and textual data, wherein the processor implementing the MM-LLM is operable to: receive a multimodal prompt comprising a visual input and a textual input, the visual input comprising a static input image depicting an input diagram having been generated using an input code segment comprising input code conforming to a specification of unified modeling language (UML), the textual input identifying an input diagram type of the input diagram; process, by the vision encoder, the visual input to generate a second plurality of visual embedding vectors representing a plurality of input diagram features of the input diagram in a first dimensional space; process, by the language model, the textual input to generate a second plurality of textual embedding vectors in a second dimensional space; project, by the vision-language connector, the second plurality of visual embedding vectors in the first dimensional space into the second dimensional space; and process, by the language model, the second plurality of visual embedding vectors and the second plurality of textual embedding vectors in the second dimensional space to generate an output code segment comprising output code conforming to the specification of UML, the output code segment when executed by the processor causing the processor to generate an output image depicting an output diagram having an output diagram type the same as the input diagram type and at least one of the plurality of input diagram features of the input diagram.

In a second aspect, the present disclosure includes a method comprising: implementing, by a processor, a multimodal large language model (MM-LLM) comprising a vision encoder, a vision-language connector, and a language model, the MM-LLM having been pre-trained using visual instruction tuning to learn alignments between visual data and textual data; receiving, by the processor, a multimodal prompt comprising a visual input and a textual input, the visual input comprising a static input image depicting an input diagram having been generated using an input code segment comprising input code conforming to a specification of unified modeling language (UML), the textual input identifying an input diagram type of the input diagram; processing, by the vision encoder, the visual input to generate a second plurality of visual embedding vectors representing a plurality of input diagram features of the input diagram in a first dimensional space; processing, by the language model, the textual input to generate a second plurality of textual embedding vectors in a second dimensional space; projecting, by the vision-language connector, the second plurality of visual embedding vectors in the first dimensional space into the second dimensional space; and processing, by the language model, the second plurality of visual embedding vectors and the second plurality of textual embedding vectors in the second dimensional space to generate an output code segment comprising output code conforming to the specification of UML, the output code segment when executed by the processor causing the processor to generate an output image depicting an output diagram having an output diagram type the same as the input diagram type and at least one of the plurality of input diagram features of the input diagram.

The following detailed description refers to the accompanying drawings. The same reference numbers in different drawings may identify the same or similar elements.

As utilized in accordance with the methods and compositions of the present disclosure, the following terms, unless otherwise indicated, shall be understood to have the meanings set forth below.

“API” means “Application Programming Interface”.

“AR” means “Augmented Reality”.

“ASIC” means “Application Specific Integrated Circuit”.

“AST” means “Abstract Syntax Tree”.

“CoT” means “Chain-of-Thought”.

“CPU” means “Central Processing Unit”.

“CSV” means “Comma-Separated Values”.

“DSP” means “Digital Signal Processor”.

“FIPA” means “Foundation for Intelligent Physical Agents”.

“FLOPS” means “Floating-Point Operations Per Second”.

“FLOS” means “Floating-Point Operations”.

“FPGA” means “Field Programmable Gate Array”.

“GPU” means “Graphics Processing Unit”.

“GUI” means “Graphical User Interface”.

“JADE” means “Java Agent Development Framework”.

“MCU” means “Microcontroller”.

“MLP” means “Multi-Layer Perceptron”.

“MMMU” means “Massive Multi-discipline Multimodal Understanding”.

“OCL” means “Object Constraint Language”.

“OCR” means “Optical Character Recognition”.

“PADE” means “Python Agent Development Framework”.

“PDF” means “Portable Document Format”.

“PG-TD” means “Planning-Guided Transformer Decoding”.

“PNG” means “Portable Network Graphic”.

“PVQA” means “Programmatic Visual Question-Answering”.

“SoC” means “System on a Chip”.

“TPU” means “Tensor Processing Unit”.

“UVF” means “Unmanned Vehicle Fleet”.

“VQA” means “Visual Question-Answering”.

“VR” means “Virtual Reality”.

Before describing various embodiments of the present disclosure in more detail by way of exemplary description, examples, and results, it is to be understood that the present disclosure is not limited in application to the details of methods and compositions as set forth in the following description. The present disclosure is capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein are for the purpose of description and should not be regarded as limiting unless otherwise indicated as so. Moreover, in the following detailed description, numerous specific details are set forth to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complications of the description.

All patents, published patent applications, and non-patent publications referenced or mentioned in any portion of the present specification, including but not limited to, U.S. Ser. No. 63/736,062, filed Dec. 19, 2024, and U.S. Ser. No. 63/776,635, filed Mar. 24, 2025, are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the terms “one or more” or “at least one” will be understood to include one as well as any quantity more than one, including but not limited to, 2, 3, 4, 5, 6, 7, 8, 9, 10, 15, 20, 30, 40, 50, 100, or any integer inclusive therein. The terms “one or more” or “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The term “plurality” generally refers to two or more items. Unless otherwise required by context, singular terms shall include pluralities and plural terms shall include the singular. Where used herein, the specific term “single” is limited to only “one,” and a “pair” means two.

Throughout this application, the terms “about” or “approximately” are used to indicate that a value includes an inherent variation. As used herein the qualifiers “about” or “approximately” are intended to include not only the exact value, amount, degree, dimension, measurement, orientation, event, circumstance, parameter, or other qualified characteristic, but are intended to include some slight variations due to measuring error, manufacturing tolerances, observer error, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described value, amount, degree, dimension, measurement, orientation, event, circumstance or parameter, or other qualified characteristic completely occurs, or occurs to a great extent or degree. For example, the term “substantially” means that the subsequently described value, amount, degree, dimension, measurement, orientation, event, circumstance, or parameter or other qualified characteristic occurs at least 80% of the time, at least 90% of the time, at least 91% of the time, at least 92% of the time, at least 93% of the time, at least 94% of the time, at least 95% of the time, at least 96% of the time, at least 97% of the time, at least 98% of the time, or at least 99% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example. Thus a reference to degrees such as 1 to 90 is intended to explicitly include all degrees in the range.

As noted above, any numerical range listed or described herein is intended to include, implicitly or explicitly, any number or sub-range within the range, particularly all integers, including the end points, and is to be considered as having been so stated. For example, “a range from 1.0 to 10.0” is to be read as indicating each possible number, including integers and fractions, along the continuum between and including 1.0 and 10.0, that is, having a minimum value equal to or greater than 1.0 and a maximum value equal to or less than 10.0, such as, for example, 3.25 to 8.65. Similarly, the wavelength range of 3 μm to 5 μm includes all fractional values within the range such as 3.0, 3.05, 3.1, 3.15, 3.2, 3.25, 3.3. 3.35, 3.4, 3.45, 3.5, 3.55, 3.6, 3.65, 3.7, 3.75, 3.8, 3.85, 3.9, 3.95, 4.0, 4.05, 4.1, 4.15, 4.2, 4.25, 4.3. 4.35, 4.4, 4.45, 4.5, 4.55, 4.6, 4.65, 4.7, 4.75, 4.8, 4.85, 4.9, 4.95, and 5.0. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Thus, even if a particular data point within the range is not explicitly identified or specifically referred to, it is to be understood that any data points within the range are to be considered to have been specified, and that the inventor(s) possessed knowledge of the entire range and the points within the range.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Where used herein, the pronouns “we” or “us” or the possessive determiner “our” are intended to refer to all persons involved in a particular aspect of the investigation disclosed herein and as such may include non-inventor laboratory personnel, assistants, technicians, collaborators and/or contributors who worked under the supervision of the inventor(s), and thus are not intended to represent an inventorship role by said laboratory personnel, assistants, technicians, collaborators, and/or contributors in any subject matter disclosed herein.

Techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The term “exemplary” is intended to mean “an example of.”

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media. The term “computer readable media” may be one or more integrated circuits.

An example system of this disclosure includes a processor; and a computer-readable medium storing instructions that are operative upon execution by the processor to perform the method described above. One or more example computer storage devices of this disclosure has computer-executable instructions stored thereon, which, upon execution by a computer, cause the computer to perform the method described herein.

Returning now to the detailed description of the systems and methods of the present disclosure, several specific, non-limiting, examples and embodiments will be discussed. The examples described below, which include particular embodiments, will serve to illustrate the practice of the present disclosure, it being understood that the particulars shown are by way of example and for purposes of illustrative discussion of particular embodiments and are presented in the cause of providing what is believed to be a useful and readily understood description of procedures as well as of the principles and conceptual aspects of the present disclosure.

The present disclosure is directed in at least certain embodiments to systems and methods which enhance the capabilities of MM-LLMs by enabling the MM-LLMs to generate executable UML code from visual diagrams autonomously. UML diagram-to-code generation demands a blend of linguistic and visual comprehension. By fine-tuning an open-source MM-LLM, the present disclosure focuses on various UML diagram types, activity, and sequence diagrams, which are used to capture the structural and behavioral elements essential in software design. Model performance is evaluated through customized metrics measuring code accuracy and structural fidelity, forming a scalable framework adaptable to real-world software development and various modeling needs. The MM-LLM reliably interprets and generates UML code from the visual elements in UML diagrams. Training emphasizes UML's structural and behavioral aspects, effectively allowing the model to analyze the relationships and interactions within activity and sequence diagrams. Recognizing UML's unique syntax and structure, the present disclosure tailors existing metrics to suit UML code generation. Additionally, image metrics were incorporated to verify that the output diagrams retain the visual and spatial integrity for high-fidelity representation.

To test the model's robustness and flexibility, a detailed performance evaluation was conducted across different UML diagram types, such as activity and sequence diagrams and varying dataset sizes and training configurations. By analyzing the impact of various model architectures and data scales on outputs, this study sheds light on factors that maximize MM-LLM performance for diagram interpretation and code generation tasks. This analysis aims to improve understanding of how fine-tuned models generalize across complex visual structures, broadening the application of the fine-tuned models to diverse software engineering contexts.

### UML Scope

While UML provides a broad standard for representing various aspects of system design, UML includes a range of diagram types, each suited to specific applications. The present disclosure focuses on two behavioral diagrams in particular: activity diagrams and sequence diagrams. Activity diagrams and sequence diagrams are classified as behavioral because the activity diagrams and sequence diagrams capture the dynamic aspects of systems, specifically how processes and workflows evolve in response to interactions and events. By concentrating on these two types of diagrams, the work enables a direct comparison, as both model workflows, albeit in different ways, highlight facets of system behavior.

Activity diagrams depict the flow of control or data within a system by outlining the steps in a process and showing a progression from one action to the next. Activity diagrams are useful for modeling business processes, workflows, or scenarios where a sequence of actions needs to be visualized. For example, an activity diagram might illustrate logging into a system, handling customer support requests, or completing a complex transaction. With the ability to represent decision point concurrent actions, and interactions with external entities, activity diagrams offer a comprehensive overview of workflows, making activity diagrams valuable for stakeholders seeking to understand operational flows and make informed design decisions.

Sequence diagrams, however, focus on the interactions between objects within a system over time. Sequence diagrams capture the sequence of messages passed between objects or components to perform a specific function, mapping out interactions and the order in which the interactions occur. Sequence diagrams are helpful in scenarios involving interdependent interactions among system components, such as server-client communications, API calls, or service orchestration within microservice architectures. A sequence diagram might detail the steps a user's request follows through various web application layers, illustrating how different components collaborate to fulfill the request.

In essence, activity and sequence diagrams visualize procedural dynamics within a system. Activity diagrams offer a higher-level view of processes, making the activity diagrams ideal for understanding control flow. In contrast, sequence diagrams delve into object interactions, providing insight into the temporal sequence of events. This distinction allows a meaningful comparison between two diagram types (i.e., activity and sequence) that model workflows yet differ in granularity and focus. Such a comparative approach supports a deeper investigation into how different UML diagrams can be interpreted and translated into code, underscoring both the adaptability and the constraints of automated methods across various diagram formats. Narrowing the focus to these specific UML diagram types limits the scope to a manageable and relevant subset of UML's broader capabilities. Concentrating on these behavioral diagrams, both in theory and practical application, provides valuable insights into the potential for UML-to-code automation in real-world development workflows, where accurately representing processes and interactions is fundamental for effective implementation and system functionality.

Code Generation with Large Language Models

Beyond small-scale applications, large enterprises have seen promising results with LLM deployments. Meta's implementation of CodeCompose, a transformer LLM, promoted an 8% productivity gain across a team of over 16,000 developers working in nine programming languages. The model demonstrated high accuracy in API recommendations and routine coding tasks; its predictive accuracy was four times higher than models relying solely on public datasets. The application streamlined repetitive or labor-intensive coding tasks in industrial environments.

Recent advancements in LLMs designed for code generation have introduced new methodologies for transforming natural language into functional code. Improvements are substantial in structured planning, where large models adapt generation processes based on context or success criteria. One method, PG-TD, enhances code generation reliability by using a planner to anticipate the success rate of generated code at each step. PG-TD employs test cases as a feedback mechanism to validate generated solutions, achieving higher accuracy than baseline Transformer models in competitive programming settings like APPS and CodeContests.

Such planning mechanisms enable LLMs to generate code resembling domain-specific syntax and functionality. Similarly, OpenAI's Codex, fine-tuned from GPT-3 on extensive GitHub datasets, represents a significant leap forward in general-purpose code generation. Codex achieves a 28.8% success rate in solving coding problems with a single attempt and reaches up to 70.2% accuracy with iterative sampling on the HumanEval dataset. This iterative approach, where multiple solutions are generated and validated against functional requirements, underscores the importance of sampling strategies in enhancing code generation quality.

LLMs have also proven versatile in networking and cybersecurity applications, areas that benefit from unstructured data processing. For example, LLMs used in network management have improved traffic optimization, demonstrating efficiency enhancements over traditional, manual methods. These models adapt to network fluctuations with minimal human intervention, though challenges persist in harmonizing data formats across diverse infrastructures. LLMs have been deployed in cybersecurity to assist with reverse binary engineering tasks. Studies have shown that GPT-4 achieved an 87% accuracy in basic code interpretation but struggled with complex malware analyses, achieving only 66% accuracy in identifying obfuscated malicious calls.

GPT-4 is a versatile code generator, advancing model-driven development by transforming UML models into various programming languages. To address the ambiguity often present in natural language prompts, an ambiguity that can disrupt code consistency, constraints like the OCL and the FIPA ontology are applied. Each constraint ensures semantic accuracy; the code aligns with UML design specifications and helps minimize cyclomatic complexity. Integrating OCL with GPT-4 has also proven to boost compatibility with frameworks such as JADE and PADE, significantly reducing the need for manual interventions. Tests conducted on UVF systems indicate that GPT-4-generated code not only aligns functionally with UML diagrams but also maintains manageable complexity, offering a robust solution for UML-based agile model-driven development.

The role of LLMs in requirements engineering has been examined, focusing on how ChatGPT can generate UML sequence diagrams from natural language requirements. ChatGPT's ability to transform textual requirements into UML-compliant diagrams was evaluated. The research highlights challenges like ambiguity and inconsistency in the natural language inputs that impact the completeness and accuracy of the diagram. ChatGPT preserves syntactic structure and consistency in terminology. However, ChatGPT needs assistance understanding domain-specific nuances when requirements contain technical jargon. ChatGPT success was observed in cases with clearly defined terms but decreased when interpreting more complex domain-specific interactions, suggesting the need for RE-specific LLM training.

A study reviewed ChatGPT's effectiveness in generating UML models. The study's experiments indicate that ChatGPT can competently create accurate models in specific domains, such as file systems. Still, ChatGPT frequently encounters problems maintaining coherence in more extensive models with complex relationships and inheritance structures. ChatGPT performance dropped considerably in more intricate domains, requiring an average of three prompts to produce comprehensive results. For models involving more than ten classes, the quality of the output diagrams showed a marked decline, with frequent syntax errors and mismatched associations. These findings highlight scalability challenges for LLMs, especially with complex UML models.

A related study presented a framework employing LLMs to assist system architects in developing structural and behavioral SysML diagrams from natural language descriptions. The framework is named TTool-AI and integrates an iterative feedback mechanism to refine LLM-generated diagrams across multiple review cycles. This feedback process is essential for identifying and addressing model errors and constraint violations, continuously guiding the LLM toward outputs that meet accuracy and syntactical standards. During each refinement phase, the model corrects deviations from SysML requirements and increasingly aligns with design specifications.

Controlled trials showed that TTool-AI achieved 85% accuracy in producing structural diagrams within three refinement cycles for simpler designs, such as a coffee machine model. This high accuracy for straightforward models suggests that the feedback mechanism effectively streamlines the LLM's output, minimizing the need for manual corrections in clearly defined and lower-complexity scenarios. However, for models with intricate interdependencies, such as those involving advanced behavioral modeling or multiple interacting components, TTool-AI often required up to 10 iterations to meet industry standards.

The study further examined TTool-AI's limitations in fully automating complex modeling tasks. While the framework successfully managed routine model components, TTool-AI continued to rely on significant human input for systems of higher complexity. The need for human oversight became particularly evident in designs that demanded strict adherence to SysML standards. Expert intervention validated and corrected model elements that posed challenges for the LLM, such as maintaining consistency across interdependent components or handling requirements specific to certain domains. These findings highlight the potential of TTool-AI for streamlining routine tasks while underscoring the challenges of achieving full automation in complex system design without expert involvement.

TTool-AI illustrates a promising model for integrating automated and human-assisted workflows in system architecture by combining iterative refinement with expert validation. The framework's success demonstrates the viability of using LLM-based tools in design processes. TTool-AI provides a relevant foundation for understanding how iterative refinement in LLMs can support accuracy and reliability in generating complex diagrams from visual inputs. TTool-AI's use of a feedback loop to refine diagrams aligns with the goal of enhancing MM-LLMs performance in UML-to-code generation. Examining TTool-AI's feedback mechanism and TTool-AI's success in reducing errors for simpler models parallels the present disclosure's approach of using specific fine-tuning methods to improve syntactic and structural fidelity in UML diagrams.

### Challenges and Limitations of Language Models

Unlike errors commonly introduced by human programmers, often stemming from logical oversights, errors generated by language models typically follow patterns tied to the models' structural and contextual processing methods. Tambon et al. developed a taxonomy highlighting standard error types unique to LLMs, such as misinterpreted syntax, neglected edge cases, and unintended prompt-driven actions. These models sometimes also introduce extra operations, such as unnecessary sorting, that were not part of the initial prompt, adding layers of complexity to debugging and validation efforts. MM-LLMs have the same reliability challenges in code generation. Models can produce logically correct but contextually inaccurate code. These intent-conflicting or context-inconsistent hallucinations can introduce errors as models generate redundant or dead code. The HALLUCODE benchmark was developed to assess and reduce these hallucinations, a step towards improving MM-LLM output filtering and validation frameworks.

Researchers are also exploring automated feedback mechanisms to reduce generation-time errors. One project categorizes automated correction strategies into training-time, generation-time, and post-hoc corrections. Generation-time strategy, such as feedback-guided decoding, lets models assess themselves (i.e., the models) against predefined standards and make adjustments on the fly. Real-time feedback mechanisms are promising, but practical challenges, like high computational costs and the difficulty of integrating external tools, such as interpreters, with LLMs, still present significant hurdles. Even so, such strategies offer a promising route toward reducing errors in complex code generation tasks. Scaling LLMs for intricate, multistep reasoning is complex. Scalability issues and inherent biases are notable, as even highly trained models can struggle to maintain logical consistency in extensive projects. Relying on open-source data also introduces biases or perpetuates existing vulnerabilities; open-source data can raise ethical and security concerns in areas like healthcare and finance. Advanced training approaches are essential to help LLMs maintain contextual relevance throughout prolonged code generation tasks.

MM-LLMs face further obstacles when aligning visual and textual information. MM-LLMs generate initial interpretations from multimodal prompts but depend on generalized patterns rather than precise input comprehension. Pattern overreliance can lead to errors in applications such as VQA for technical diagrams, where context-specific accuracy is central. MM-SPUBENCH addresses this by identifying and correcting biases where models inappropriately weigh non-essential visual attributes. In light of these challenges, fine-tuning has emerged as a transformative strategy to enhance the performance of LLM and MM-LLM. One in-depth review of fine-tuning methodologies shows how supervised, unsupervised, and instruction-based approaches can adapt models to task-specific requirements and reduce errors. Fine-tuning is a process in machine learning where a pre-trained model is further trained on a specific dataset to adapt the pre-trained model to a new task or domain. The fine-tuning technique allows the pre-trained model to leverage the general knowledge the pre-trained model learned during initial training while refining the pre-trained model's understanding to meet specific requirements. The proposed seven-stage pipeline spans from data preparation through post-deployment monitoring. Domain-specific dataset preparation and resource-efficient strategies play a role in achieving scalable, quality results. Fine-tuning methods address code hallucinations.

Recent refinements in fine-tuning approaches reveal that models trained on targeted, task-oriented instructions can generalize more effectively and excel in challenging benchmarks. Approaches like CoT fine-tuning support multi-step logical processing. CoT is a fine-tuning approach in which a model is trained to generate intermediate reasoning steps or explanations before reaching a final answer. This method helps the model break down complex tasks into logical steps, mimicking how humans often think through problems and is capable of producing logically consistent and contextually relevant code.

In MM-LLM applications, fine-tuning with specialized multimodal datasets mitigates alignment errors; fine-tuning improves the model's responsiveness to textual and visual cues. Such advancement allows for efficient diagram analysis for UML code generation. While pre-trained LLMs and MM-LLMs offer considerable potential, fine-tuning remains essential for optimizing performance, minimizing bias, and ensuring contextual accuracy. As fine-tuning techniques evolve, especially with advancements in instruction-based and CoT fine-tuning, the reliability of these models in high-stakes applications, such as healthcare and finance, is poised to improve, signaling promising directions for future research and real-world applications.

### VQA and Diagram Analysis

VQA is an important framework to MM-LLMs. Techniques like modular processing and context-sensitive learning in VQA frameworks have emerged as powerful tools for adapting these models to visual data. Modular frameworks like CodeVQA redefine VQA as a structured code generation task. The structured generation allows models to decompose the tasks into various parts, bypassing extensive retraining. By decomposing diagrams into parts such as object detection, spatial relations, and logical structuring, CodeVQA demonstrates how MM-LLMs can handle diverse visual inputs, including UML diagrams, facilitating improved code generation outputs.

CodeVQA's method is distinctive in using pre-trained language models to produce Python code that orchestrates a range of visual queries. Through few-shot prompting, MM-LLMs adapt on the fly to various VQA tasks. The model might pinpoint object positions within a diagram and perform logical operations to determine spatial relationships for the code generation process. Translating this output into modular Python scripts allows MM-LLMs to yield logical, interpretable results across diverse question formats, particularly valuable for converting diagrammatic data into structured code. Further advancing these modular principles, PyramidCoder introduces a hierarchical approach to code generation for compositional VQA. PyramidCoder is a hierarchical framework designed to enhance PQVA by structuring the process into three levels: query rephrasing, code generation, and answer aggregation.

In the initial phase, the framework rephrases the original query into multiple variations, capturing different interpretations and nuances to broaden the scope for potential solutions. Building upon these rephrased queries, the subsequent level generates multiple code candidates corresponding to each variation, thereby increasing the likelihood of formulating an accurate and effective solution. In the final stage, PyramidCoder evaluates the generated code candidates and aggregates their outputs to determine the optimal answer. PyramidCoder selects the most appropriate code based on predefined criteria to ensure accuracy and relevance to the original query. In comparative tests on the GQA, VQAv2, and NLVR2 datasets, PyramidCoder showed substantial improvements, with accuracy gains of up to 2.9% on the NLVR2 dataset compared to CodeVQA. PyramidCoder's use of rephrasing and aggregation is beneficial in scenarios with multi-step reasoning.

Based on the two previous works, AdaCoder employs an adaptive prompt compression framework that decreases computational demands without compromising high-quality code generation performance in VQA tasks. Addressing a central challenge in VQA-based code generation, the need for extensive API documentation within prompts, which can inflate token length and add complexity, crafts prompts fine-tuned for specific question types, including only essential code snippets. The compression enables AdaCoder to cut token length without compromising accuracy, marking a significant step forward in developing scalable, efficient VQA models for code generation.

The practical benefits of AdaCoder's adaptive compression and prompt selection extend to UML-to-code applications. For instance, AdaCoder's structured prompts allow the model to choose relevant predefined functions (e.g., identifying class relationships or spatial orientation) based on question type, aligning closely with UML diagram analysis. In UML-based code generation, where a precise understanding of dependencies and object hierarchies is essential, AdaCoder's adaptive selection reduces computational load. It focuses on particular diagram elements, enabling more efficient and context-sensitive code output.

In the context of UML code generation, frameworks like these empower developers to focus on particular components of a diagram, such as class dependencies or method hierarchies, which are essential to organizing code architecture effectively. Recent advancements in modular processing techniques, adaptive prompt compression, and interactive visualization provide a strong foundation for this thesis. By integrating structured, optimized approaches from VQA, it becomes possible to refine multimodal large language models MM-LLMs specifically for UML-based code generation, creating a seamless link between diagram interpretation and executable code creation.

Diagram and Graph to Code using Language Models

The potential of MM-LLMs to translate diagrammatic data into structured code has driven exploratory studies to use these models for UML-based code generation, such as assessing the ability of LLMs to convert UML class diagram images into machine-readable formats. While proprietary models like GPT-4 achieved 100% syntactic fidelity, open-source alternatives like CogVLM experienced syntax errors in 55.6% of cases due to omissions and hallucinations, particularly with increased diagram complexity. These findings underscore a need to enhance structural and syntactic fidelity in LLMs for UML-to-code applications, where high precision and context awareness are essential.

Translating dense visual data into code remains a core challenge, as demonstrated by Plot2Code and ChartMimic, which prioritize benchmarks on code accuracy and visual fidelity. Plot2Code tests LLMs on generating executable code from scientific plots, with GPT-4 achieving 73.2%, the best accuracy rate. Structured visuals are a significant issue in UML settings, where slight inaccuracies in relationships or dependencies can render the code non-functional. Prior studies indicate that improved tuning bolsters structural and logical fidelity as LLMs engage with increasingly complex UML diagrams. Results from prior work suggested a need for enhanced tuning to improve structural and logical fidelity as LLMs handle more complex UML diagrams.

Refined prompt engineering and modular frameworks also show promise in enhancing LLM performance for complex, visual-to-code tasks. Design2Code's capabilities in converting web design screenshots into front-end code were assessed. The model achieved a 64% visual fidelity through specialized prompts and a modular task approach. This methodology aligns closely with Code-VQA, where modular frameworks allow models to adapt dynamically to diverse visual inputs with minimal retraining. This modularity enables the models to capture intricate relationships within complex data structures while reducing computational demands.

While advancements have been made in model accuracy through specialized benchmarks and structured prompts, existing research largely centers on class diagrams, sequence diagrams, or front-end design. Activity diagrams present unique demands, requiring high relational accuracy to maintain logical coherence in generated code. The prevalence of sequence diagrams also makes sequence diagrams a point of study. The present disclosure addresses this gap by developing a methodology for fine-tuning MM-LLMs, which generate executable UML code from sequence and activity diagrams. The present disclosure integrates computational analysis across training and evaluation phases, pinpointing specific error types that inhibit model performance and using metrics to analyze metric performance. The method deepens the understanding of relational and sequential fidelity, which is preferred for practical software engineering applications. The present disclosure presents a significant advancement in addressing error types that challenge accurate code generation by providing a thorough error analysis and demonstrating adaptability across various LLMs and software engineering environments.

### Methodology

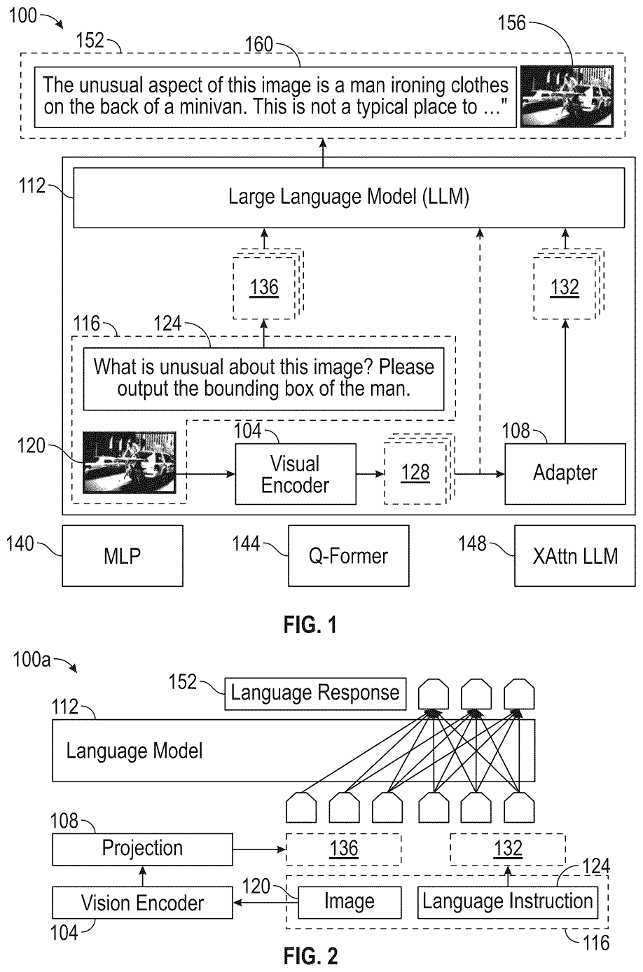

Referring now to the present disclosure and in particular to FIG. 1, shown therein is an exemplary embodiment of an MM-LLM 100 constructed in accordance with the present disclosure. As shown in FIG. 1, the MM-LLM 100 may comprise a vision encoder 104 (also referred to herein as a “visual encoder”), a vision-language connector 108 (also referred to herein as a “projection bridge” and an “adapter”), and a language model 112. The MM-LLM 100 may be operable to receive a multimodal prompt 116 comprising a visual input (i.e., a static input image 120) and a textual input (i.e., a text prompt 124).

The vision encoder 104 may be operable to process the static input image 120 to generate a plurality of visual embedding vectors 128 representing a plurality of features of the static input image 120 in a first dimensional space (i.e., a vision space). In the embodiment shown in FIG. 1, the static input image 120 depicts a man ironing clothes on the back of a minivan, while the text prompt 124 includes the text “What is unusual about this image? Please output the bounding box of the man.”

In some embodiments, the vision encoder 104 may comprise a vision transformer (ViT). ViTs are deep learning models configured to perform image recognition tasks by dividing images into patches, embedding such patches into vectors, and processing such vectors using a transformer encoder to capture relationships between the patches.

The vision-language connector 108 may be operable to project the visual embedding vectors 128 in the first dimensional space into a second dimensional space (i.e., a language space) to generate a plurality of language-aligned visual embedding vectors 132. In some embodiments, the vision-language connector 108 comprises one or more of an MLP 140, a Q-Former 144, and a cross-attention LLM 148.

The language model 112 may be operable to process the text prompt 124 to generate a plurality of textual embedding vectors 136 in the second dimensional space and process the language-aligned visual embedding vectors 132 and the textual embedding vectors 136 in the second dimensional space to generate a multimodal response 152 comprising a visual output (i.e., an output image 156) and a textual output (i.e., a text response 160). In some embodiments, the language model 112 may be an LLM.

In the embodiment shown in FIG. 1, the output image 156 depicts the man ironing clothes on the back of the minivan with a bounding box surrounding the man, while the text response 160 includes the text “The unusual aspect of this image is a man ironing clothes on the back of a minivan. This is not a typical place to iron . . . .”

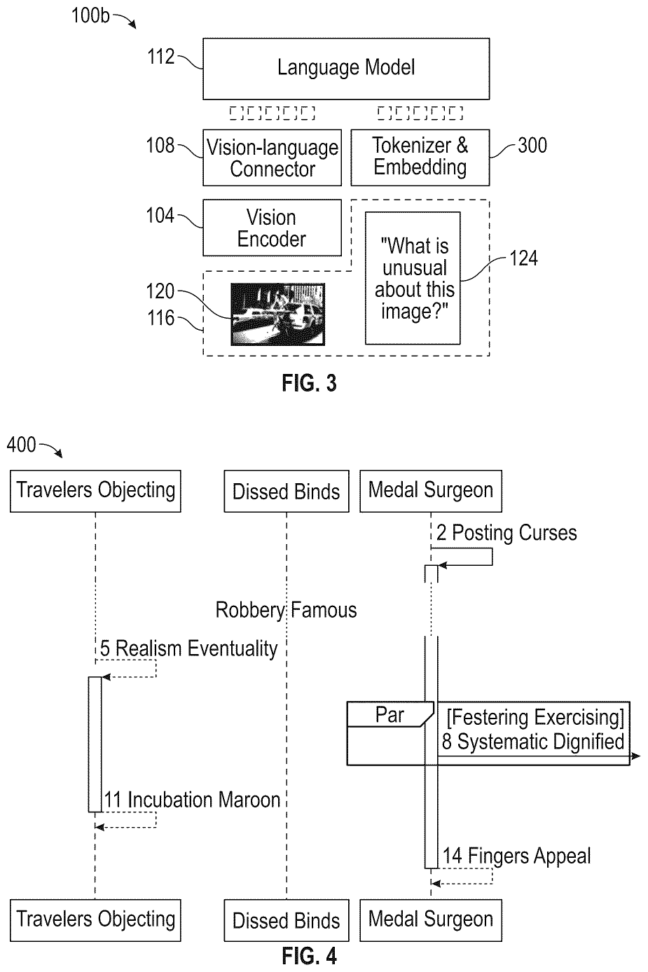

Referring now to FIG. 2, shown therein is an exemplary embodiment of a LLaVA-based MM-LLM 100a (hereinafter, the “LLaVA model 100a”) constructed in accordance with the present disclosure. As shown in FIG. 2, the LLaVA model 100a may comprise the vision encoder 104, the vision-language connector 108, and the language model 112.

The vision encoder 104 may be operable to employ a LoRA method to “extract” visual features from the static input image 120 (i.e., process the static input image 120 to generate the visual embedding vectors 128 representing the features of the static input image 120). In some embodiments, the vision encoder 104 of the LLaVA model 100a is a CLIP-based vision encoder. CLIP may utilize ViTs as image encoders but may also support other architectures, such as ResNet, for example.

The vision-language connector 108 may be operable to “map” the visual features (i.e., project the visual embedding vectors 128 in the first dimensional space into the second dimensional space to generate the language-aligned visual embedding vectors 132) to the language model 112. In some embodiments, the vision-language connector 108 is a projection bridge. In some such embodiments, the vision-language connector 108 is a projection matrix implementing a linear transformation.

The language model 112 may process the visual features and the text prompt 124 (i.e., process the text prompt 124 to generate the textual embedding vectors 136 in the second dimensional space and process the language-aligned visual embedding vectors 132 and the textual embedding vectors 136 in the second dimensional space) to generate text-based outputs (i.e., the text response 160) “based on” the visual features. The text response 160 may include descriptions and/or code based on the visual features. In some embodiments, the language model 112 is a Vicuna-based language model.

Automating UML code generation from images requires a sophisticated model capable of understanding and processing multimodal data. Given the structural and semantic intricacies of translating UML diagrams into executable code, this thesis relies on LLaVA and its enhanced variant, LLaVA-1.5, as foundational models. MM-LLMs are suited to this task because MM-LLMs can process textual and visual information, thereby supporting the model's capacity to interpret, analyze, and respond to complex visual inputs like UML diagrams. The selection of LLaVA and LLaVA-1.5 aligns with the primary objectives of this research, which aim to facilitate the accurate conversion of visual UML elements into functional code. LLaVA integrates a vision encoder, specifically CLIP, with a robust language model, Vicuna. The vision encoder and language models enable the extraction of detailed semantic information from images and utilize this data for language-based tasks, bridging a gap in UML automation where structural fidelity and syntactic accuracy are preferred.

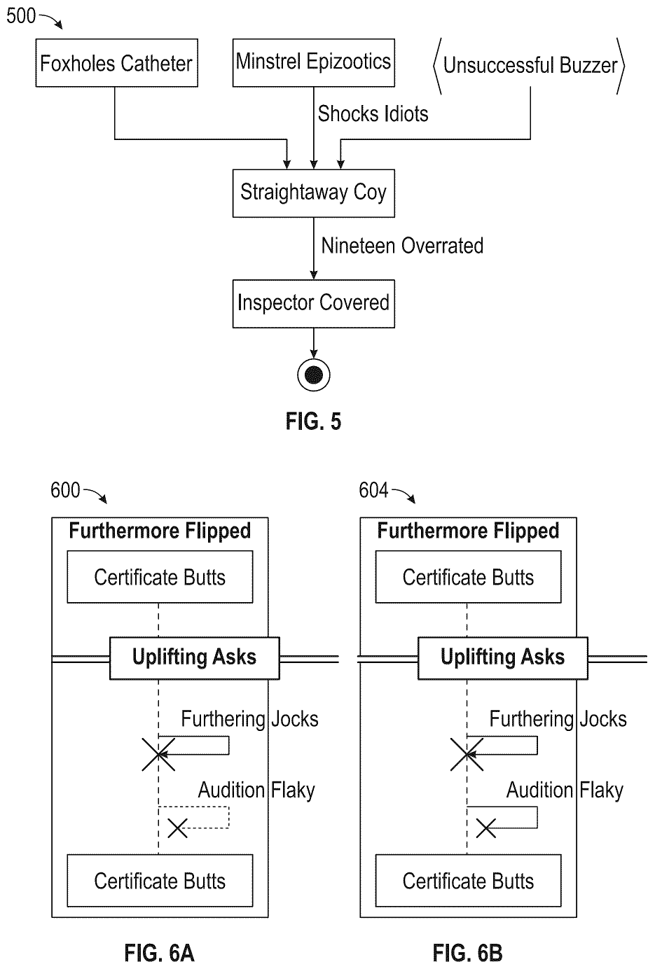

Referring now to FIG. 3, shown therein is an exemplary embodiment of a LLaVA-1.5-based MM-LLM 100b (hereinafter, the “LLaVA-1.5 model 100b”) constructed in accordance with the present disclosure. As shown in FIG. 3, the LLaVA-1.5 model 100b may comprise the vision encoder 104, the vision-language connector 108, the language model 112, and a tokenizer and/or embedding module 300 (hereinafter, the “tokenizer 300”). FIG. 3 further illustrates the pathway by which visual data (i.e., the visual embedding vectors 128) flows from the vision encoder 104 to the language model 112 via the vision-language connector 108.

In some embodiments, the vision encoder 104 of the LLaVA-1.5 model 100b is a CLIP ViT-L/336px-based vision encoder.

In some embodiments, the vision-language connector 108 is a single projection bridge or a linear projection layer. In other embodiments, however, the vision-language connector 108 is an MLP-based vision-language connector. Providing the LLaVA-1.5 model 1006 with the MLP-based vision-language connector in lieu of a linear projection layer may enable more complex feature interactions between the vision encoder 104 and the language model 112.

In some embodiments, the language model 112 may be a Vicuna v1.5 13 B-based language model.

In the subsequent analysis, LLaVA's role as a baseline model is contrasted with its updated version, LLaVA-1.5. LLaVA-1.5 introduces architectural enhancements that build on the original LLaVA design, notably replacing the linear projection layer between the vision and language components with an MLP. The architectural shift allows LLaVA-1.5 to achieve a more complex and nuanced integration between visual and linguistic data. Such integration improved performance on tasks requiring a detailed understanding of visual inputs, including complex UML diagrams.

The LLaVA models also undergo visual instruction tuning. Visual instruction tuning is a training process that aligns visual inputs, such as images of UML diagrams, with corresponding textual outputs like code descriptions or interpretations. The tuning process enables both LLaVA and LLaVA-1.5 to align visual features with language outputs accurately. The alignment makes LLaVA and LLaVA-1.5 effective for tasks that demand close adherence to structural details in UML diagrams. The enhanced tuning procedures applied in LLaVA-1.5, which includes broader exposure to VQA and diagram interpretation datasets, further support its application in this work. The advanced dataset exposure strengthens the model's ability to generalize across different UML diagram types, ultimately contributing to improved accuracy in UML-based code generation.

### Fine-Tuning and LoRA Fine-Tuning

While the base model has general solid capabilities, the detailed nature of some UML diagrams means that the untrained model struggles with task-specific UML syntax and structure. Fine-tuning enables the model to be tailored to better handle the UML diagram's demands. Throughout the present disclosure, ‘full fine-tuning’ and ‘standard fine-tuning’ are used interchangeably to update the full model parameters using task-specific data. Additionally, terms like ‘base model’ and ‘baseline model’ are used interchangeably with ‘original model,’ referring to the pre-trained LLaVA model before fine-tuning.

Four models across two fine-tuning strategies: a fully fine-tuned model with 7 billion parameters (hereinafter, the “7 B full model”), a LoRA fine-tuned model with 7 billion parameters (hereinafter, the “7 B LoRA model”), a fully fine-tuned model with 13 billion parameters (hereinafter, the “13 B full model”), and a LoRA fine-tuned model with 13 billion parameters (hereinafter, the “13 B LoRA model”). The model sizes represent different trainable parameters, with the larger model having more. Standard fine-tuning updates all the model parameters, while LoRA introduces trainable low-rank matrices that reduce the computational burden by focusing on updating only selected layers. LoRA allows for efficient adaptation of large language models, such as LLaVA-1.5.

LoRA reduces the number of trainable parameters by inserting trainable low-rank matrices into the architecture. Instead of updating the full set of model parameters, LoRA selectively updates the low-rank components of specific layers, reducing memory consumption. Despite this reduction in complexity, LoRA fine-tuning has achieved performance levels comparable to full fine-tuning in several larger-scale language models. Given the scale of models like LLaVA-1.5, using LoRA enables the model to maintain computational efficiency while adapting effectively to the unique demands of UML diagram analysis.

### Hyperparameters

Several hyperparameters were employed during the fine-tuning process. Hyperparameters are configuration settings that are defined before training and govern the learning process, such as learning rate, batch size, and model architecture, for example. Hyperparameters differ from model parameters learned from the data during training. While some hyperparameters, such as the learning rate and batch size, are common across standard and LoRA fine-tuning, others are specific to LoRA. The hyperparameters used were consistent with the original implementation of LLaVA-1.5 to ensure an accurate representation of the architecture. Table 1 summarizes the hyperparameters used for both fine-tuning strategies.

TABLE 1
Hyperparameters for LoRA Fine-Tuning and Standard Fine-Tuning

| | LoRa Fine- | Standard Fine- |
|---|---|---|
| Description | Tuning | Tuning |
| lora_enable | True | None |
| lora_r | 128 | None |
| lora_alpha | 256 | None |
| mm_projector_lr | 2e−5 | None |
| learning_rate | 2e−4 | 2e−5 |
| per_device_train_batch_size | 16 | 8 |
| gradient_accumulation_steps | 4 | 4 |

The hyperparameters lora r and lora alpha are specific to LoRA fine-tuning. lora r controls the rank of the low-rank matrices introduced into the model. A higher value for lora r increases the expressive power of these matrices, allowing for more nuanced adaptations, but this comes with improved memory and computational requirements, lora alpha is a scaling factor determining the influence of the low-rank matrices during training. A higher lora alpha increases the impact of matrices on the model output, making such matrices more significant in the learning process. The mm projector lr hyperparameter refers to the projector layer's learning rate. Because LoRA updates only a subset of parameter values, the projector learning rate helps ensure that these updates are balanced with the rest of the model during LoRA fine-tuning. In LoRA fine-tuning, a higher learning rate and larger batch size are used, as fewer parameters are updated than standard fine-tuning, allowing the model to converge more efficiently.

### Synthetic Data Generation

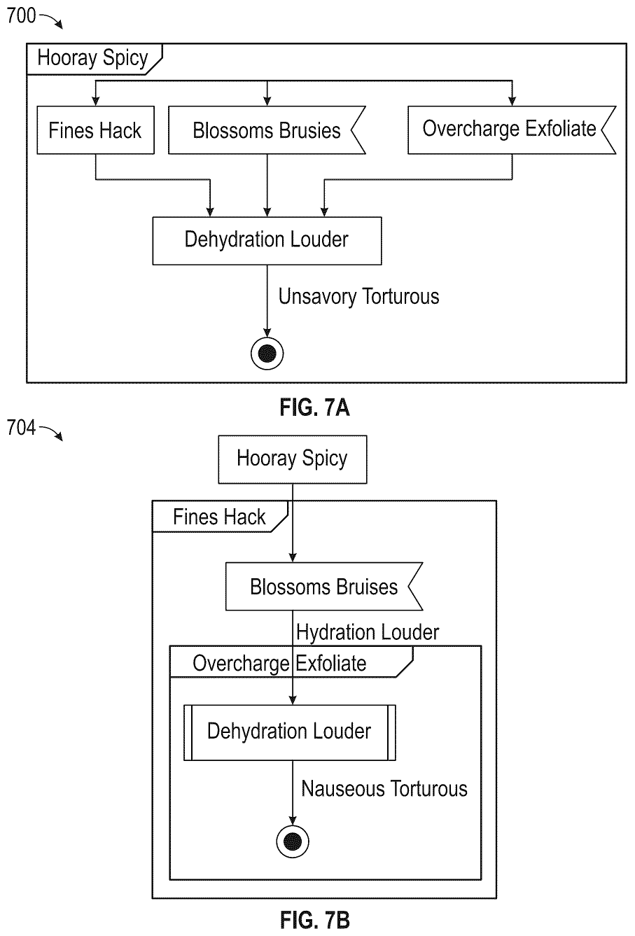

Two synthetic UML diagrams, activity and sequence, were employed to train the models. Random text strings were created using PlantUML syntax and selected from the dictionary of popular words and phrases to generate these diagrams. PlantUML syntax is a textual language used to describe diagrams concisely and human-readably. The syntax allows developers and designers to create UML diagrams directly from text, which is rendered into visual diagrams. PlantUML is an open-source tool that allows users to create diagrams from plain text, including UML. Random string selection provides for diversity and effectively mimics real-world diagrams with UML representations. As a result, the datasets become easily scalable. The structure of the diagrams was also randomized. Specifically, as shown in FIG. 4, participants, messages, and activation events were rearranged in a sequence diagram 400 based on the following code:

@startuml
participant “travelers objecting” as 0
participant “dissed binds” as 1
participant “medal surgeon” as 2
autonumber 2 3
2 -> 2++ : posting curses
...robbery famous...
0 --> 0++ : realism eventuality
par festering exercising
2 ->] : systematic dignified
end
return incubation maroon
return fingers appeal
@enduml

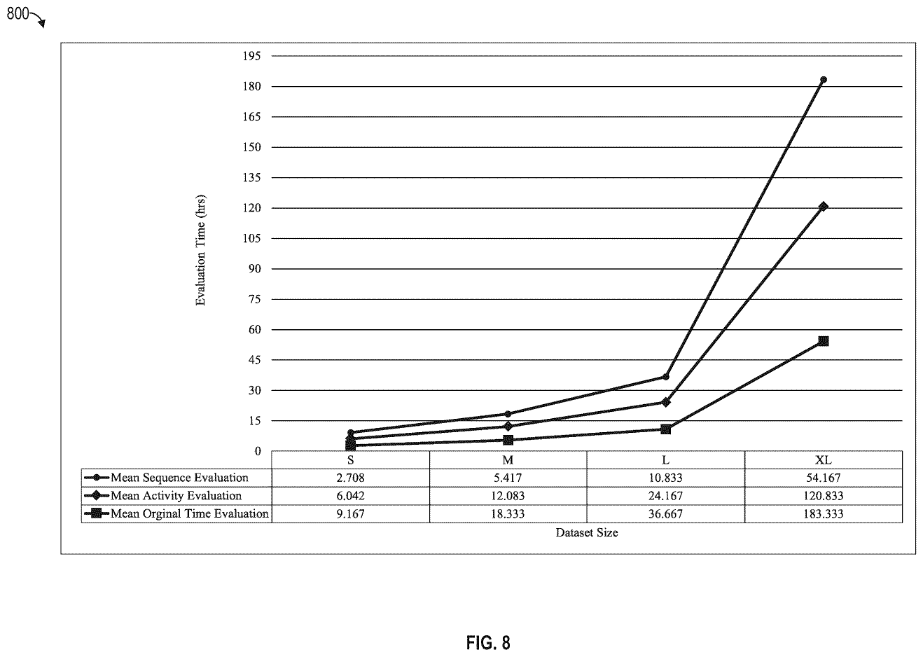

Similarly, as shown in FIG. 5, swimlanes and activity statements were used for an activity diagram 500 based on the following code:

@startuml
split
-[hidden]->
:foxholes catheter;
split again
-[hidden]->
:minstrel epizootics
-> shocks idiots;
split again
-[hidden]->
:unsuccessful buzzer; <<continuous>>
end split
:straightaway coy;
-> nineteen overrated;
:inspector covered; <<task>>
stop
@enduml

Once generated, each diagram was saved as a text file and assigned a unique identifier to prevent duplication or overlap with others. PlantUML was then run over the UML text files to create quality PNG diagrams. Large, diverse datasets can be made by generating synthetic data, addressing the challenge of limited access to annotated UML diagrams. Studies have supported the effectiveness of synthetic data; in some cases, models trained on synthetic data outperform those trained on real-world data. Synthetic data has proven strong in tasks requiring multimodal understanding.

### Dataset Breakdown

Activity and sequence diagram types were divided into four dataset sizes, small, medium, large, and extra-large, each varying in the number of diagrams and their corresponding code files. Four models were trained for each dataset size: the 7 B LoRA model, the 13 B LoRA model, the 7 B full model, and the 13 B full model. In addition to these trained models, the original, untrained 7 B model (hereinafter, the “7 B original model”) and the original, untrained 13 B model (hereinafter, the “13 B original model”) were evaluated, leading to six assessed models for each dataset size.

Each model was trained separately on sequence data or activity data. The two data types were not merged or mixed during the training process. Separating sequence and activity diagrams ensures the models are optimized for each task without interference from unrelated diagram types. Table 2 provides a detailed breakdown of the number of diagrams (and corresponding code files) used for training and testing across the various dataset sizes for activity and sequence diagrams.

The training data comprises three components: the prompt, the UML diagram image, and the corresponding UML code in text format. Each diagram is paired with its respective code. First, the UML diagram is created as a ‘.png’ image using PlantUML.jar and saved. Next, the corresponding UML code is stored as text files, tokenized to align with the language model's input format. UML code serves as the ground truth for training. The dataset was prepared using a Python script that processes all images and their respective text files to generate the JSON files. An example of the formatted JSON data for LLaVA is given below:

{“id”: “unique-id-1234”, “image”:
“path/to/image.png” “conversations”:
[{“from”: “human”, “value”: “<image>\n Please generate the UML code.
{“from”: “gpt”, “value”: “Expected UML code output here...”}]}

TABLE 2
Breakdown of Dataset Sizes for Training and Testing

| Dataset Size | Dataset Type | Training Size | Testing Size |
|---|---|---|---|
| Small | Activity | 6,000 | 1,500 |
| Medium | Activity | 12,000 | 3,000 |
| Large | Activity | 24,000 | 6,000 |
| Extra Large | Activity | 120,000 | 30,000 |
| Small | Sequence | 6,000 | 1,500 |
| Medium | Sequence | 11,994 | 2,998 |
| Large | Sequence | 23,994 | 5,998 |
| Extra Large | Sequence | 119,994 | 29,998 |

### Evaluation Metrics

The present disclosure proceeded on the basis that using large datasets and larger model sizes will increase performance scores on both BLEU and SSIM metrics, reflecting improved textual accuracy and visual fidelity in the generated UML code. Simultaneously, these configurations are expected to yield decreased error rates, indicating fewer syntax, structural alignment discrepancies, and overall diagram accuracy. While both LoRA fine-tuning and standard fine-tuning are predicted to yield comparable improvements in BLEU and SSIM scores, LoRA fine-tuning is expected to outperform full fine-tuning in terms of computational efficiency, demonstrated by reduced training time and computational resources, while maintaining similar accuracy.

The present disclosure incorporates error analysis metrics to assess the effectiveness of model configurations across dataset sizes and fine-tuning approaches. Error metrics, such as syntax error rates and diagram mismatches, will clarify the specific impact of larger models and datasets in reducing common model-generated errors, thus comprehensively assessing the models' overall effectiveness. This analysis will also gauge how LoRA fine-tuning's efficiency compares to Full fine-tuning regarding computational requirements, offering insights into optimal configurations for balancing resource use and output quality in UML code generation tasks. The hypothesis thus aims to validate that larger datasets and models improve accuracy and fidelity metrics performance. LoRA fine-tuning offers a computational advantage without compromising the quality of code and diagram generation, highlighting its suitability for scalable UML-to-code automation tasks in software engineering workflows.

The BLEU metric has become one of the most commonly used tools for assessing text generation, especially in machine translation. BLEU evaluates UML code generation by comparing the n-grams (i.e., sequences of words) in the generated code against a reference. BLEU indicates how closely the generated code aligns with a reference by measuring syntactic similarities calculated from the n-grams. A higher BLEU score implies a more accurate representation of the ground truth code. BLEU's simplicity, independence from specific languages, and scalability make it well-suited for handling large datasets of generated code.

SSIM is a well-established and trusted metric for assessing image quality. It is useful for comparing generated images, such as UML diagrams, with a reference. SSIM focuses on luminance, contrast, and structure, making it closer to how humans perceive visual differences. SSIM evaluates image quality into a score ranging from −1 to 1; lower scores indicate more differences. SSIM is useful in scenarios where the overall layout and structure of the image matter more than pixel-perfect accuracy, such as when comparing generated UML diagrams to ground truth. SSIM prioritizes structural integrity. The alignment of elements, shapes, and relationships between segments is more important than minor pixel differences. SSIM's focus on structural features, such as the edges, lines, and overall layout, makes it a much more meaningful metric than MSE, which tends to treat all pixel variations, large or small, with equal weight.

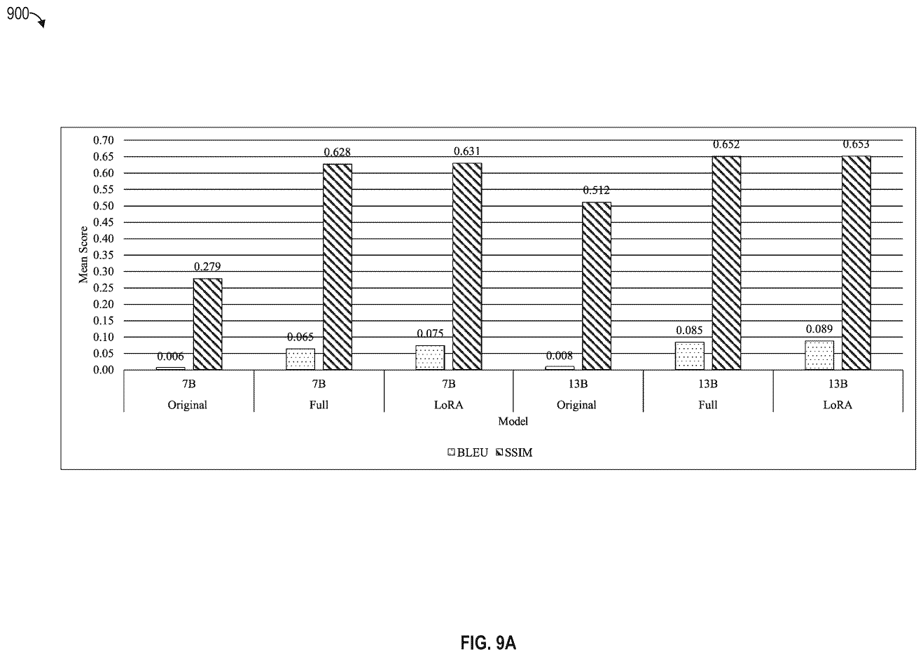

As illustrated in FIGS. 6A and 6B, an output diagram 604 (shown in FIG. 6B) with high SSIM and BLEU scores closely aligns with a ground truth diagram 600 (shown in FIG. 6A), both structurally and in content. A high SSIM score signifies that the output diagram 604 retains strong visual fidelity, preserving spatial arrangements, alignment, and component layout compared to the ground truth diagram 600. Meanwhile, a high BLEU score confirms textual accuracy, showing that the model has effectively reproduced the labels, keywords, and annotations of the ground truth diagram 600. High SSIM and BLEU scores underscore the MM-LLM's ability to maintain structural integrity and semantic content, producing the output diagram 604 such that it is visually and textually consistent with the ground truth diagram 600.

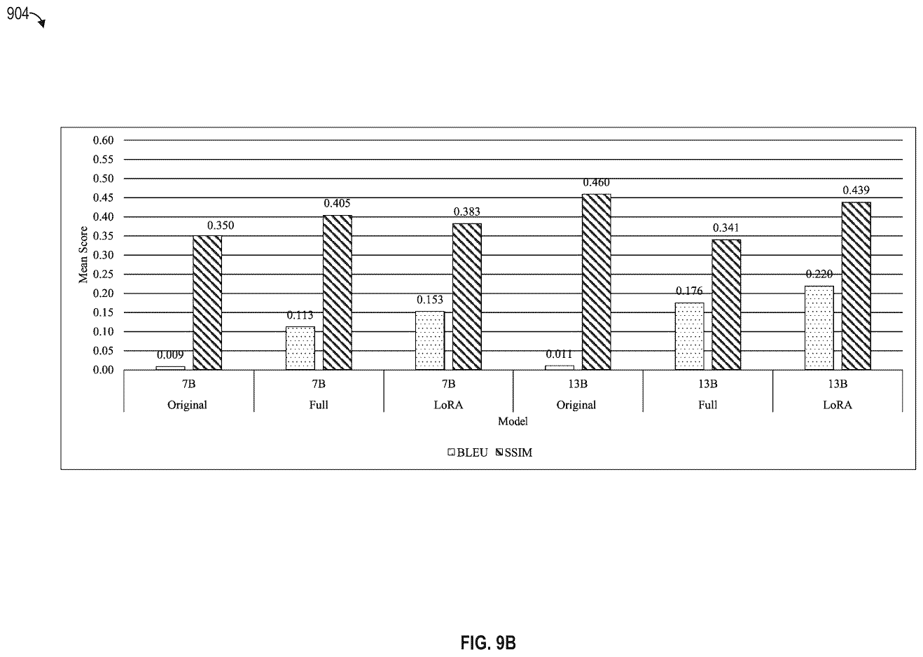

Conversely, as illustrated in FIGS. 7A and 7B, an output diagram 704 (shown in FIG. 7B) with low SSIM and BLEU scores exhibit notable deviations from a ground truth diagram 700 (shown in FIG. 7A). A low SSIM score suggests misalignment or incorrect positioning of visual elements, which disrupts the overall layout and compromises the spatial relationships for unambiguous interpretation. The low BLEU score reflects textual inaccuracies, such as misplaced or incorrect labels, reducing the alignment of the output diagram 704 with the ground truth diagram 700. Errors diminish visual and textual resemblance, indicating that the model fails to capture the structural and semantic aspects of the original accurately. The contrast emphasizes the importance of high SSIM and BLEU scores for effective diagram generation, where both structural precision and textual accuracy are preferred for usability in UML-based code generation.

Several computational metrics assess how our models handle growing datasets and increasing parameters. These metrics include FLOS, training time, samples per second, steps per second, training loss, and evaluation time. Total FLOS represents the computational requirements during training, summing all floating-point operations performed across the entire training process. Unlike FLOPS, which measures the rate of operations in a single second, total FLOS offers a cumulative estimate. A higher FLOS shows increased computational demands as the model size or dataset grows. There is a positive correlation between FLOS and training time; as FLOS increases, so does the time to complete a training cycle. Training time computes the time for a pass across the whole dataset. By evaluating training time across multiple models, it is possible to measure the computational scalability of each configuration. Training loss quantifies the discrepancy between the model's predictions and the actual target values it aims to replicate. When the training loss decreases and remains stable over time, the model is learning effectively. Continuous error reduction translates into improved accuracy in the model's predictions.

Samples per second, often called throughput, measure the number of data samples the model can process per unit of time. A higher value indicates that the model is more efficient at handling large volumes of data in less time. In conjunction with throughput, steps per second gauge how many gradient update steps the model completes per second. Steps per second complement samples per second, which are often correlated, reflecting the model's data processing efficiency. Evaluation time measures how long it takes for a trained model to output a response to image-prompt pairs. Shorter evaluation times indicate a model's response length. More complicated, longer diagrams have longer evaluation times and models that give overly verbose responses. Identifying any lag in evaluation time highlights potential bottlenecks in the model design.

The core focus of the error analysis was evaluating the performance of UML diagram and code generation models by looking at syntax, UML presence, and diagram type match. All metrics are structured so that lower values indicate fewer errors. The error analysis process was automated using a Python script, with errors extracted from logs and mapped to corresponding UML and code files. Results were then exported to a CSV file after the scores were calculated. Using Python, counting methods were automated to identify syntax errors across the generated files. The syntax metric determines whether the diagrams can be correctly rendered. Syntactic issues, such as missing symbols or incomplete code blocks, affect the output's usability as syntactic issues produce diagrams that cannot be compiled or interpreted correctly. As discussed earlier, files that cannot be compiled are rendered in black with green text.

The UML absence score counts how many generated code files are entirely missing. UML code files are flagged under this metric if the UML code files contain generic or irrelevant content placeholders, such as non-relevant text (e.g., ‘I am sorry I cannot read the diagram in the image’) or non-UML annotations. This score is a straightforward indicator of instances where model output is irrelevant or unusable from a UML perspective. The absence of UML code is the most severe of all the errors from a code generation perspective, as it implies the model failed even to attempt the basic task requested in the prompt. The diagram mismatch score quantifies discrepancies between the generated UML diagrams and their reference counterparts. Rather than focusing on visual pixel differences, this metric evaluates diagram elements' logical arrangement and accuracy. For example, if the model were asked to generate a sequence diagram but instead produced an event diagram, this mismatch would increase the score, indicating failure to align with the requested diagram type.

### Results

This section evaluates how the LLaVA-1.5 models perform across various datasets and scenarios, focusing on both computational efficiency and the quality of the output diagrams compared to the ground truth. The computational analysis considers the total time spent and the overall training loss. The methodology states that BLUE and SSIM are used to assess model performance. These metrics provide insight into how well the models generate diagrams, examining aspects such as fluency, accuracy, and structural similarity to their original counterparts. Beyond performance evaluations, an error analysis was performed on the types of mistakes that emerge in diagram generation. Error analysis focuses on syntax issues, the absence of UML code, and mismatching diagram types.

### Training Time and Computational Trends

The training time and efficiency metrics for various activity datasets, ranging from small to extra-large, are presented in Tables 3 and 4. The number of steps per second increases with the dataset size, reflecting computational demand as the model processes more samples per second. Despite the increase in steps, the rate at which each model processes steps remains consistent within the same model architecture across dataset sizes. For instance, the 7 B full model maintains approximately 0.081 steps per second for small, medium, and large datasets. Likewise, the 13 B full model processes around 0.044 steps per second across datasets. Stability indicates that steps per second are determined by the model's internal complexity rather than by dataset size. Larger datasets take more steps to complete each second, which increases overall training time.

As dataset and model sizes increase, training time rises significantly; training the 7 B full model on the small dataset takes just 0.161 hours while training the 13 B full model on the extra-large dataset takes 5.948 hours. The LoRA models exhibit slightly longer training times due to additional computations, with the 13 B LoRA model taking 9.002 hours for the extra-large dataset compared to 5.948 hours for the full model. The consistent processing speed within a given model type (e.g., 7 B or 13 B) shows that training time is more dependent on the dataset size rather than fluctuations in model architecture.

### Throughput and Training Loss

Throughput decreases as dataset and model sizes increase. As shown in Table 3, the 7 B full model on the small dataset processes 10.335 samples per second, while the same model on the extra-large dataset processes only 5.604 samples per second as seen in Table 4. Larger models, such as the 13 B LoRA model, experience an even sharper drop, processing only 3.703 samples per second for the extra-large dataset. Training loss follows an inverse trend, decreasing as dataset and model size increase; the 7 B full model has a training loss of 2.20 on the small dataset, while the 13 B LoRA model achieves a lower loss of 1.553 on the extra-large dataset. The lower loss values suggest that larger datasets and models enhance generalizability. Computational complexity grows with dataset and model sizes, as FLOS indicates. The small dataset with the 7 B full model takes 8.721×10¹³ FLOSs. The extra-large dataset with the 13 B full model takes 2.484×10¹⁵ FLOS, reflecting the heavier computational burden of more extensive datasets and complex models. Larger datasets also take more steps per second, and processing rates remain consistent within a given model type, causing total training time increases.

TABLE 3
Training Time Metrics for Activity Datasets by Model Size: 7B Model

| | | | | Training | Train | Train | | |
|---|---|---|---|---|---|---|---|---|
| Dataset | Model | Model | Batch | Time | Samples | Steps | Train | Total |
| Size | Type | Size | Size | (hrs) | Per sec | Per sec | Loss | FLOS |
| Small | Full | 7B | 8 | 0.161 | 10.335 | 0.081 | 2.20 | 8.721 × 10¹³ |
| Small | LoRA | 7B | 16 | 0.252 | 6.626 | 0.052 | 2.22 | 9.731 × 10¹³ |
| Medium | Full | 7B | 8 | 0.323 | 10.305 | 0.080 | 1.924 | 1.857 × 10¹⁴ |
| Medium | LoRA | 7B | 16 | 0.507 | 6.578 | 0.051 | 1.924 | 2.066 × 10¹⁴ |
| Large | Full | 7B | 8 | 0.658 | 10.127 | 0.079 | 1.830 | 3.880 × 10¹⁴ |
| Large | LoRA | 7B | 16 | 1.38 | 6.423 | 0.050 | 1.800 | 4.326 × 10¹⁴ |

TABLE 4
Training Time Metrics for Activity Datasets by Model Size: 13B Model

| | | | | Training | Train | Train | | |
|---|---|---|---|---|---|---|---|---|
| Dataset | Model | Model | Batch | Time | Samples | Steps | Train | Total |
| Size | Type | Size | Size | (hrs) | Per sec | Per sec | Loss | FLOS |
| Small | Full | 13B | 8 | 0.284 | 5.862 | 0.046 | 1.945 | 1.090 × 10¹⁴ |
| Small | LoRA | 13B | 16 | 0.432 | 3.858 | 0.30 | 1.953 | 1.217 × 10¹⁴ |
| Medium | Full | 13B | 8 | 0.577 | 5.774 | 0.045 | 1.867 | 2.321 × 10¹⁴ |
| Medium | LoRA | 13B | 16 | 0.891 | 3.743 | 0.29 | 1.871 | 2.583 × 10¹⁴ |
| Large | Full | 13B | 8 | 1.180 | 5.650 | 0.044 | 1.777 | 4.851 × 10¹⁴ |
| Large | LoRA | 13B | 16 | 1.784 | 3.736 | 0.29 | 1.769 | 5.408 × 10¹⁴ |
| Extra | Full | 13B | 8 | 5.948 | 5.604 | 0.044 | 1.569 | 2.484 × 10¹⁵ |
| Large | | | | | | | | |
| Extra | LoRA | 13B | 16 | 9.002 | 3.703 | 0.29 | 1.553 | 2.772 × 10¹⁵ |
| Large | | | | | | | | |

### Comparison Between Activity and Sequence Datasets

Sequence datasets take less training time than activity datasets, as seen in Tables 5 and 6. For instance, the 7 B full model takes 0.121 hours to train on the small sequence dataset compared to 0.161 hours for the small activity dataset, with this trend continuing across larger datasets. Sequence datasets also exhibit faster step rates. The 7 B full model processes 0.108 steps per second for sequence data, compared to 0.081 steps per second for activity data, suggesting that sequence data allows for more efficient step processing. Similarly, throughput is higher for sequence datasets, with the 7 B full model processing 13.738 samples per second on the small sequence dataset versus 10.335 samples per second on the small activity dataset. This indicates that sequence data is less complex and takes fewer operations per sample. Training loss is lower for sequence datasets. For example, the 7 B full model on the small sequence dataset has a loss of 0.615 compared to 2.20 for the small activity dataset. The trend persists with larger models and datasets. Activity datasets demand more FLOS. The 7 B full model on the small activity dataset takes 8.721×10¹³ FLOS, compared to 4.003×10¹³ FLOS for the small sequence dataset. This computational overhead grows with model size and dataset size, reflecting the increased complexity of activity data.

TABLE 5
Training Time Metrics for Sequence Datasets by Model Size: 7B Model

| | | | | Training | Train | Train | | |
|---|---|---|---|---|---|---|---|---|
| Dataset | Model | Model | Batch | Time | Samples | Steps | Train | Total |
| Size | Type | Size | Size | (hrs) | Per sec | Per sec | Loss | FLOS |
| Small | Full | 7B | 8 | 0.121 | 13.738 | 0.108 | 0.615 | 4.003 × 10¹³ |
| Small | LoRA | 7B | 16 | 0.190 | 8.758 | 0.069 | 0.574 | 9.731 × 10¹³ |
| Medium | Full | 7B | 8 | 0.240 | 13.864 | 0.108 | 0.502 | 8.121 × 10¹³ |
| Medium | LoRA | 7B | 16 | 0.374 | 8.897 | 0.069 | 0.474 | 8.545 × 10¹³ |
| Large | Full | 7B | 8 | 0.483 | 13.802 | 0.108 | 0.380 | 1.699 × 10¹⁴ |
| Large | LoRA | 7B | 16 | 0.753 | 8.852 | 0.069 | 0.357 | 1.777 × 10¹⁴ |

TABLE 6
Training Time Metrics for Sequence Datasets by Model Size: 13B Model

| | | | | Training | Train | Train | | |
|---|---|---|---|---|---|---|---|---|
| Dataset | Model | Model | Batch | Time | Samples | Steps | Train | Total |
| Size | Type | Size | Size | (hrs) | Per sec | Per sec | Loss | FLOS |
| Small | Full | 13B | 8 | 0.214 | 7.805 | 0.061 | 0.544 | 5.005 × 10¹³ |
| Small | LoRA | 13B | 16 | 0.334 | 4.995 | 0.39 | 0.515 | 5.285 × 10¹³ |
| Medium | Full | 13B | 8 | 0.427 | 7.801 | 0.060 | 0.433 | 1.15 × 10¹⁴ |
| Medium | LoRA | 13B | 16 | 0.642 | 5.189 | 0.40 | 0.417 | 1.068 × 10¹⁴ |
| Large | Full | 13B | 8 | 0.95 | 7.819 | 0.061 | 0.324 | 2.124 × 10¹⁴ |
| Large | LoRA | 13B | 16 | 1.313 | 5.075 | 0.40 | 0.314 | 2.222 × 10¹⁴ |
| Extra | Full | 13B | 8 | 4.290 | 7.770 | 0.061 | 0.178 | 1.075 × 10¹⁵ |
| Large | | | | | | | | |
| Extra | LoRA | 13B | 16 | 6.514 | 5.117 | 0.40 | 0.171 | 1.123 × 10¹⁵ |
| Large | | | | | | | | |

### Evaluation Time

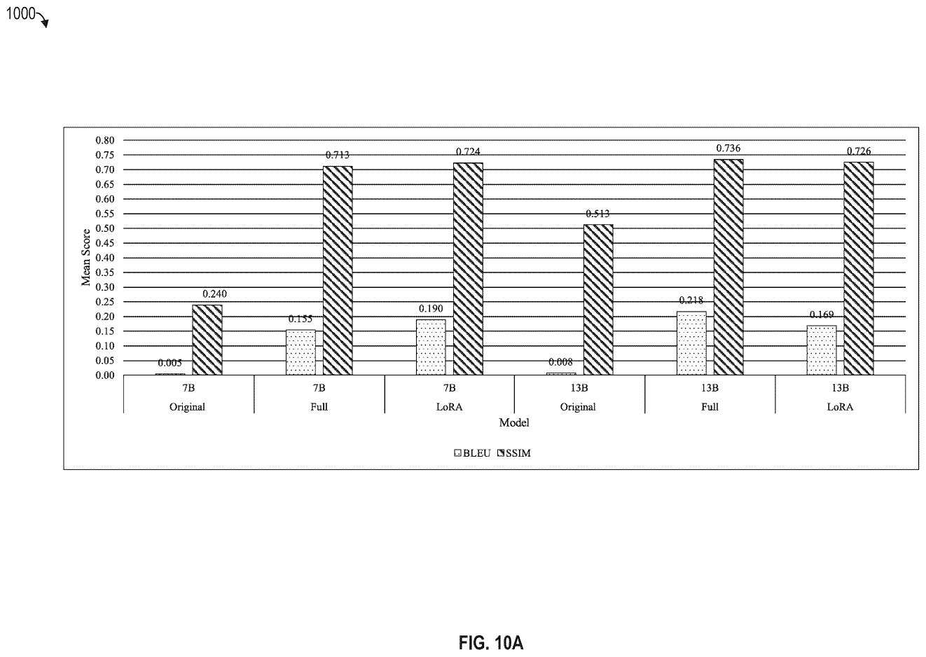

In a graph 800 shown in FIG. 8, the evaluation time for models is shown, as well as a non-fine-tuned base model. It is worth noting that the main factors influencing evaluation time are the model's response length to image-prompt pairs and the number of pairs rather than the complexity of the data itself. Regarding sequence models, the evaluation time increases with dataset size, ranging from 2.708 hours for the small dataset to 54.167 hours for the extra-large dataset. The increase can be attributed to the larger number of image-prompt pairs, which require the model to generate more responses. The straightforward structure of sequence data results in concise model outputs, keeping evaluation time lower. Models fine-tuned on activity data show an increase in evaluation time. Evaluation time starts at 6.042 hours for the small dataset and reaches 120.833 hours for the extra-large dataset.

The complex structure of activity diagrams leads to longer, more detailed responses, increasing the evaluation time compared to sequence models. As dataset size grows, the difference in evaluation times between sequence and activity models becomes more pronounced. The non-fine-tuned baseline model exhibits the longest evaluation times across all dataset sizes. It starts at 9.167 hours for the small dataset and escalates to 183.333 hours for the extra-large dataset. This model typically generates overly verbose and often incorrect responses, extending evaluation beyond sequence and activity. The results indicate that evaluation time, rather than training time, becomes the primary bottleneck as datasets scale. Therefore, optimizing evaluation processes and reducing unnecessary response lengths is preferred when deploying models on large datasets. Fine-tuning models for concise and accurate responses play a role in mitigating evaluation time, as demonstrated by the stark difference between the baseline and fine-tuned models. However, the final factor is dataset size.

### Model Performance

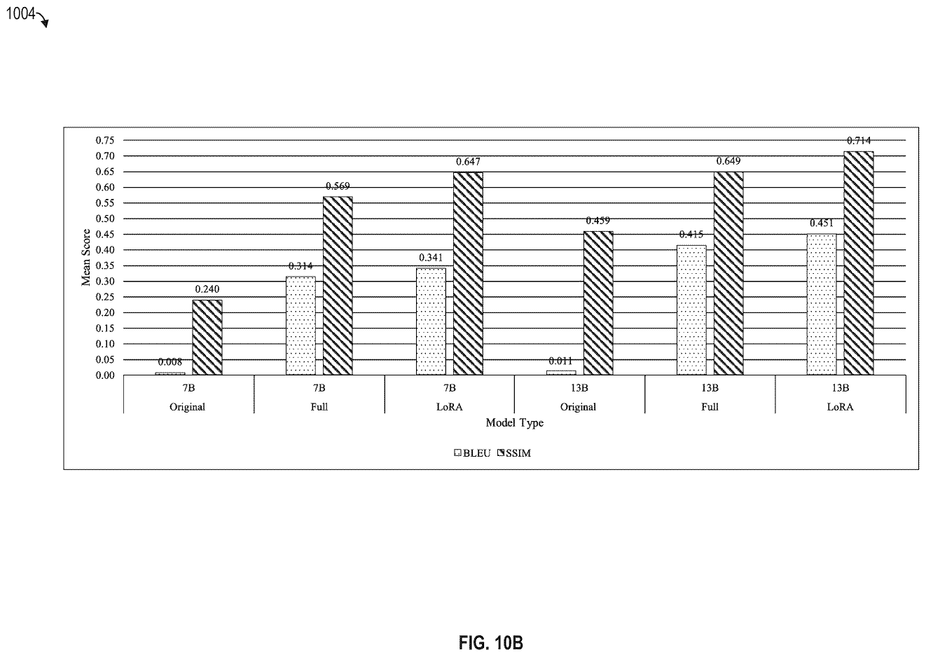

The BLEU score, evaluating syntactic accuracy, increased with larger datasets. For the small activity dataset (as shown in a graph 900 shown in FIG. 9A), the 7 B original model had a low BLEU score of 0.006, which was lower than both the 7 B full model (0.065) and the 7 B LoRA model (0.075). The 13 B original model also performed poorly, with a BLEU score of 0.008. Further, the 13 B full model had a BLEU score of 0.085 and the 13 B LoRA model had a BLEU score of 0.089. For the small sequence dataset (as shown in a graph 904 shown in FIG. 9B), the 7 B original model had a low BLEU score of 0.009, which was lower than both the 7 B full model (0.113) model and the 7 B LoRA model (0.153). The 13 B original model also performed poorly, with a BLEU score of 0.11. Further, the 13 B full model had a BLEU score of 0.176 and the 13 B LoRA model had a BLEU score of 0.220. The low values highlight the difficulty of generating accurate outputs for complex activity data in smaller datasets.

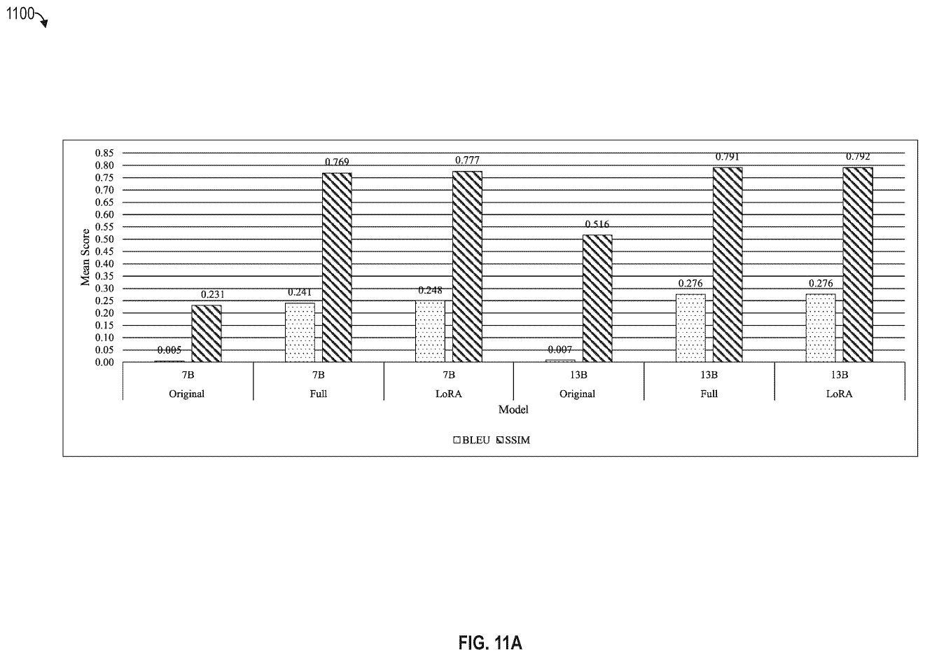

For the medium activity dataset (as shown in a graph 1000 shown in FIG. 10A), the 7 B original model had a BLEU score of 0.005, while the 7 B full model had a BLEU score of 0.155 and the 7 B LoRA model had a BLEU score of 0.190. The 13 B original model had a BLEU score of 0.005, the 13 B full model had a BLEU score of 0.218, and the 13 B LoRA model had a BLEU score of 0.169. For the medium sequence dataset (as shown in a graph 1004 shown in FIG. 10B), the 7 B original model had a BLEU score of 0.008, while the 7 B full model had a BLEU score of 0.314 and the 7 B LoRA model had a BLEU score of 0.341. The 13 B original model had a BLEU score of 0.011, the 13 B full model had a BLEU score of 0.415, and the 13 B LoRA model had a BLEU score of 0.451.

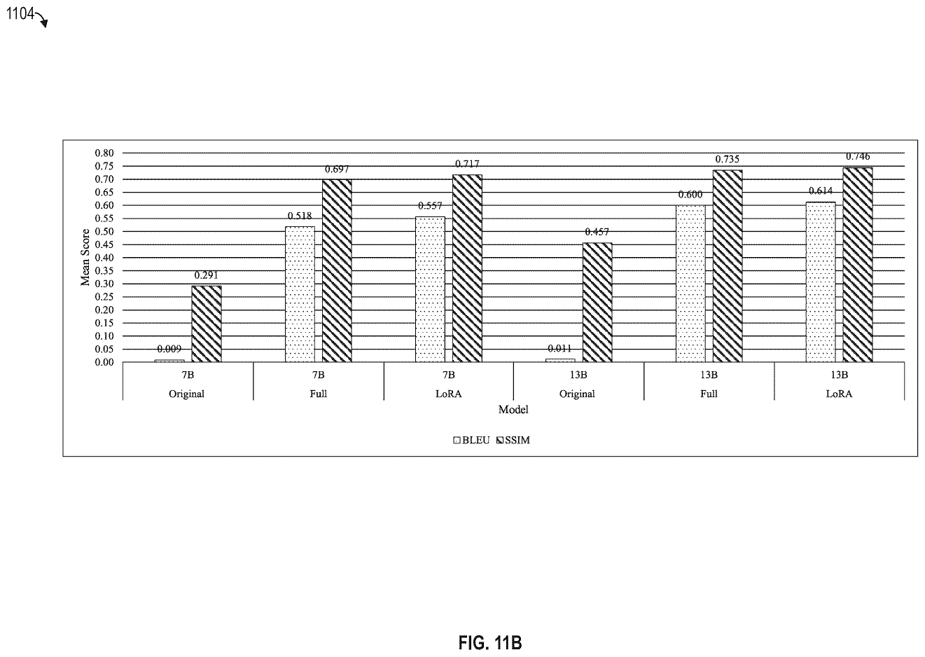

For the large activity dataset (as shown in a graph 1100 shown in FIG. 11A), the 7 B original model had a BLEU score of 0.005, while the 7 B full model had a BLEU score of 0.241 and the 7 B LoRA model had a BLEU score of 0.248. The 13 B original model had a BLEU score of 0.007, the 13 B full model had a BLEU score of 0.276, and the 13 B LoRA model had a BLEU score of 0.276. For the large sequence dataset (as shown in a graph 1104 shown in FIG. 11B), the 7 B original model had a BLEU score of 0.009, while the 7 B full model had a BLEU score of 0.518 and the 7 B LoRA model had a BLEU score of 0.557. The 13 B original model had a BLEU score of 0.011, the 13 B full model had a BLEU score of 0.600, and the 13 B LoRA model had a BLEU score of 0.614.

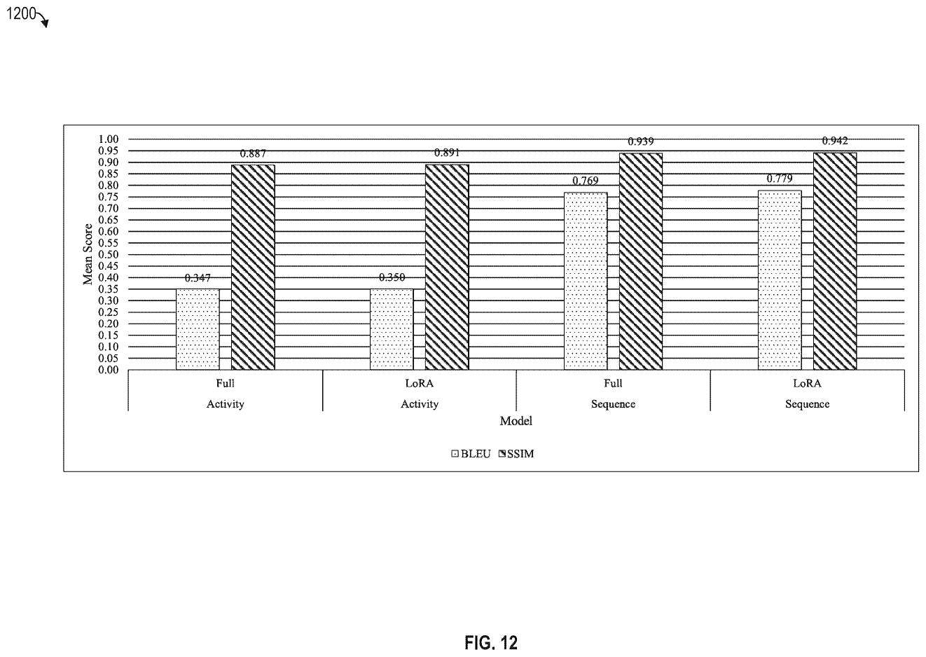

Low values decreased the larger the dataset. For the extra-large dataset (as shown in a graph 1200 in FIG. 12), the 13 B full model achieved a BLEU score of 0.347 for activity data and 0.769 for sequence data, indicating that larger datasets enhance text generation capabilities. Similarly, the 13 B LoRA model achieved a BLEU score of 0.350 for activity data and 0.779 for sequence data, showcasing greater alignment with reference.

SSIM, which assesses the structural similarity of output diagrams to ground truth images, followed a similar trend. For the small activity dataset (shown in the graph 900 shown in FIG. 9A), the 7 B original model scored 0.279, while the 7 B full model and the 7 B LoRA model scored 0.628 and 0.631, respectively. Further, the 13 B original model scored 0.512, while the 13 B full model and the 13 B LoRA model scored 0.652 and 0.653, respectively. The small sequence dataset (shown in the graph 904 shown in FIG. 9B) saw better performance, with the 7 B original model scoring 0.350, while the 7 B full model and the 7 B LoRA model scoring 0.405 and 0.383, respectively. Further, the 13 B original model scored 0.460, similar to the 13 B full model (0.460) and the 13 B LoRA model (0.439).

For the medium activity dataset (shown in the graph 1000 shown in FIG. 10A), the 7 B original model scored 0.240, while the 7 B full model and the 7 B LoRA model scored 0.713 and 0.724, respectively. Further, the 13 B original model scored 0.513, while the 13 B full model and the 13 B LoRA model scored 0.736 and 0.726, respectively. For the medium sequence dataset (shown in the graph 1004 shown in FIG. 10B), the 7 B original model scored 0.240, while the 7 B full model and the 7 B LoRA model scoring 0.569 and 0.647, respectively. Further, the 13 B original model scored 0.459, while the 13 B full model scored 0.649 and the 13 B LoRA model scored 0.714.

For the large activity set (shown in the graph 1100 shown in FIG. 11A), the 7 B original model scored 0.231, while the 7 B full model and the 7 B LoRA model scored 0.769 and 0.777, respectively. Further, the 13 B original model scored 0.516, while the 13 B full model and the 13 B LoRA model scored 0.791 and 0.792, respectively. For the large sequence set (shown in the graph 1104 shown in FIG. 11B), the 7 B original model scored 0.291, while the 7 B full model and the 7 B LoRA model scored 0.697 and 0.717, respectively. Further, the 13 B original model scored 0.457, while the 13 B full model and the 13 B LoRA model scored 0.735 and 0.746, respectively.

SSIM scores improved with larger datasets. For the extra-large dataset (shown in the graph 1200 shown in FIG. 12), the 13 B full model achieved 0.887 for activity data and 0.939 for sequence data, while the 13 B LoRA model achieved 0.891 for activity data and 0.942 for sequence data. Results suggest that fine-tuning helps models better capture structural details as datasets increase.

### Comparison Across Data Types and Models

Across all dataset sizes, models trained on sequence data outperformed those trained on activity data in terms of BLEU scores, with the 13 B LoRA model achieving the highest scores of 0.779 for BLEU and 0.942 for SSIM on sequence data in the extra-large dataset (shown in the graph 1200 shown in FIG. 12). The most likely reason is the more direct nature of sequence data compared to the complexity of activity data, which demands more intricate language and structure. LoRA fine-tuning consistently enhanced performance across all metrics and dataset sizes. LoRA models outperformed full models in BLEU and SSIM scores, with the most noticeable improvement in sequence datasets. However, the performance gap between full and LoRA models was smaller for activity data, suggesting that while LoRA fine-tuning is beneficial, its impact is less pronounced when dealing with more complex data like activity diagrams.

### Syntactical Errors

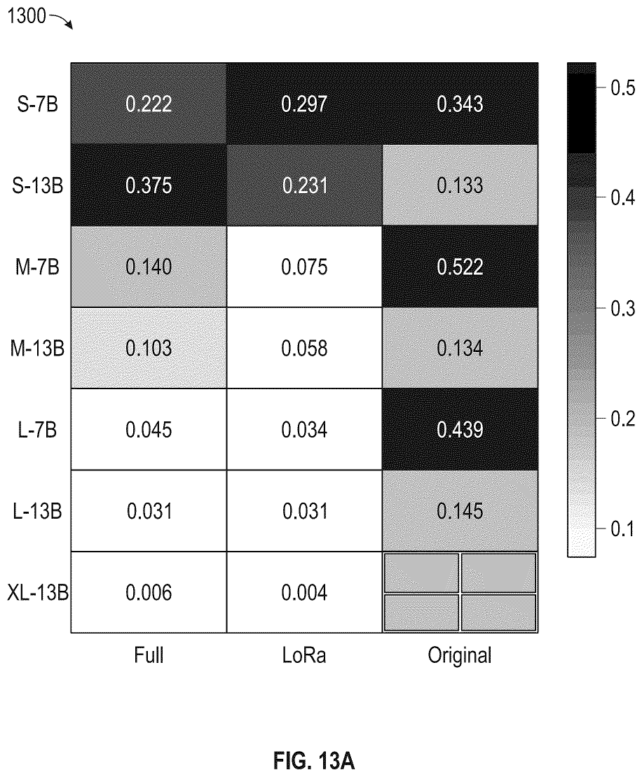

The 7 B original model exhibits the highest syntax error rate across all dataset sizes when creating sequence diagrams (as shown in a heatmap 1300 shown in FIG. 13A). It achieves scores of 0.343 for the small dataset and 0.522 for the medium dataset and stabilizes at 0.439 for the large dataset. The 7 B full model and the 7 B LoRA model reduced the error rate, but the 7 B LoRA model shows less improvement with a syntax error rate of 0.297. A similar error reduction trend is observed for the 13 B models. The 13 B original model exhibits a syntax error rate of 0.133 for the small dataset, which improves for larger datasets. The 13 B full model shows significant improvement, achieving a syntax error rate of 0.375 for the small dataset and decreasing with increasing dataset size. The 13 B LoRA model achieves the lowest syntax error rate across all configurations for medium (0.058) and large (0.31) datasets.

The generation of activity diagrams presents higher error rates than sequence diagrams for the original models. As seen in a heatmap 1304 shown in FIG. 13B, the 7 B original model exhibits the most significant syntax error rate, scoring 0.623 for the small dataset and rising to 0.682 for the large dataset. This indicates that the complexity of activity diagrams poses a more significant challenge for the original models. The 7 B full model reduces syntax errors, starting at 0.12 for the small dataset and maintaining relatively low error rates across larger datasets. The LoRA variant also performs well, with an error rate of 0.19 for the small dataset.

However, the improvement across increasing dataset sizes becomes less pronounced after the initial error reduction. FIGS. 13A and 13B show that after the initial reduction, the syntax error for the activity diagram is lower than the sequence for most models. The 13 B original model faces similar challenges, with an error rate of 0.227 for the small dataset. However, the 13 B full model and the 13 B LoRA model reduce errors. The 13 B LoRA model achieves the lowest syntax error rate of 0.006 for the extra-large dataset, suggesting that larger models and fine-tuning techniques enhance performance when generating complex activity diagrams.

### Comparison Between Sequence and Activity Diagrams

When comparing the performance of sequence and activity diagrams, it becomes evident that activity diagrams exhibit fewer syntax errors, particularly in the full and LoRA configurations. Conversely, sequence diagrams tend to have higher syntax error rates. An exception is observed in the original (untuned) models, where sequence diagrams exhibit lower error rates. However, significant improvements in the standard and LoRA configuration underscore the effectiveness of enhancements in handling complex diagram generation tasks, as illustrated in FIGS. 13A and 13B. The syntax error trends align with SSIM scores; sequence diagrams exhibit a higher average BLEU score, and the SSIM scores were often poorer. The lower scores can now be attributed to the increased presence of syntax errors, which degrade the overall image quality. Specifically, the syntax errors in sequence diagrams often produce corrupted or incomplete images, such as black or green error images, which bear little resemblance to the intended diagrams. As a result, syntax errors negatively impact the overall image quality of sequence diagrams.

The methodology section describes the UML absence score as a measure of the instances where the model did not generate UML code in response to a prompt. Table 7 illustrates that only the baseline models exhibited non-zero absence scores, with fine-tuned models resolving this issue. Table 7 shows that only the original models (the 7 B original model and the 13 B original model) displayed any UML absence errors. Fine-tuned models did not have any instances of missing UML code, indicating a significant improvement in their performance. For small datasets, the 7 B original model had a UML absence score of 0.0007 for both sequence and activity datasets. The 13 B original model had no UML absence errors for small datasets, but errors were present in medium and large datasets, although at low rates. A notable outlier is the 7 B original model on the medium-sized sequence dataset, which has a higher UML absence score of 0.0023, twice the size of the next most significant error. Nevertheless, these are very small values, suggesting that even the baseline model infrequently omits creating UML code when directly prompted.

TABLE 7
UML Absence and Diagram Mismatch Scores
by Data Size and Model Type

| | | Sequence | Activity | Sequence | Activity |
|---|---|---|---|---|---|
| | | UML | UML | Diagram | Diagram |
| Data | Model | Absence | Absence | Mismatch | Mismatch |
| Size | Size | Score | Score | Score | Score |
| Small | 7B | 0.0007 | 0.0007 | 0.3567 | 0.3633 |
| Small | 13B | 0 | 0 | 0.526 | 0.75 |
| Medium | 7B | 0.0023 | 0.001 | 0.5254 | 0.367 |
| Medium | 13B | 0.0003 | 0.0007 | 0.4693 | 0.7687 |
| Large | 7B | 0.001 | 0.0003 | 0.3141 | 0.3433 |
| Large | 13B | 0.0003 | 0 | 0.56 | 0.7538 |

Another significant error is the incorrect diagram creation. The diagram mismatch score indicates the frequency with which the model generated an incorrect diagram type compared to the one requested in the prompt. Once again, the baseline models exhibited higher mismatch rates, while fine-tuned models did not have this issue. The increase emphasizes another improvement in the model's accuracy in following prompts after fine-tuning. The 13 B original model, in particular, struggled with activity diagrams, reaching a mismatch score of 0.75 for the small dataset and 0.754 for the large dataset. On the sequence side, the 7 B original model had a mismatch score of 0.357 for small datasets, which increased to 0.525 for medium datasets. Most mismatches occurred when the models produced class diagrams instead of the requested diagram type; the mismatches reveal a tendency to create class diagrams for the LLaVA-1.5 model, which could be extrapolated to other models outside the LLaVA family.

### Result Overview

The experimental hypothesis posited that larger models and datasets would improve performance on BLEU and SSIM metrics, leading to enhanced accuracy and reduced error rates. Additionally, LoRA fine-tuning was expected to yield results similar to full fine-tuning while being more computationally efficient. The findings largely validated this hypothesis, though with some nuanced insights regarding LoRA's computational efficiency and batch size limitations. The model performance analysis indicates that larger models, particularly the 13 B configurations, paired with fine-tuning techniques such as LoRA consistently outperformed smaller baseline models across all major metrics, supporting the hypothesis that model size positively impacts performance. Larger models showed reduced syntax error rates and greater fidelity to the ground truth diagrams, as seen in FIGS. 13A and 13B. The improvement was noticeable in sequence diagrams, where the larger models achieved higher BLEU scores. However, while sequence diagrams achieved higher BLEU scores, their visual output quality sometimes suffered due to syntax errors, degrading the over-all SSIM scores. The improvement aligns with the hypothesis that larger models enhance metric performance but also reveals challenges in balancing syntactic accuracy with visual fidelity.

For the more complex activity diagrams, fine-tuning proved beneficial, reducing errors and increasing image fidelity, thereby validating the hypothesis that fine-tuning improves performance on more challenging tasks. Nonetheless, activity diagrams exhibited deviations from the ground truth even with fine-tuning, suggesting that their complexity continues to pose challenges. This finding highlights the importance of continued refinement to meet the hypothesis fully in terms of accurately capturing all diagram types. As anticipated, increasing the dataset size from small to extra-large led to improvements across all sequence and activity diagram metrics. Larger datasets expanded the models' learning capacity, resulting in better generalization, fewer errors, and more substantial alignment with reference diagrams.

The trend confirms that larger datasets enhance performance and underscores the scalability benefits of combining extensive training data with fine-tuning. The most significant gains were observed in fine-tuned models trained on the largest datasets, indicating that dataset scale and fine-tuning contribute jointly to model scalability and effectiveness. Notably, fine-tuning also reduced errors related to UML absence and diagram mismatches, with only the original models displaying non-zero UML absence scores. This outcome supports the hypothesis by demonstrating fine-tuning's impact on enhancing prompt adherence and completeness regarding LoRA fine-tuning, the hypothesis that it would provide similar results to fine-tuning while being computationally efficient was partially validated. Although LoRA fine-tuning yielded comparable or even slightly better BLEU and SSIM scores than full fine-tuning, particularly on complex activity diagrams, it unexpectedly took longer to train overall. This slower training time was primarily due to a smaller batch size (8 for LoRA vs. 16 for standard fine-tuning), which limited the number of samples processed per step, resulting in lower train samples per second. However, LoRA fine-tuning achieved a higher train step per second rate, likely because LoRA only updates a subset of parameters using low-rank matrices, making each step more efficient regarding parameter updates.

The results suggest that while LoRA is computationally efficient per step, batch size constraints may impact overall training time, especially with larger datasets. An unexpected finding that emerged was that LoRA fine-tuned models often outperformed Full fine-tuned models in BLEU and SSIM scores. This indicates that LoRA's targeted parameter updating provides efficiency and may enhance the model's ability to capture nuances in UML structure and syntax. Despite longer training times, LoRA's better performance on diagrams suggests that it may be a better option for tasks that require high fidelity in structured data, such as UML code generation.

The experimental hypothesis was largely confirmed: larger datasets and models improved BLEU and SSIM scores while fine-tuning (both LoRA and Full) reduced errors and improved diagram accuracy. Although LoRA was not faster regarding total training time, it achieved efficiency per step and provided superior performance on certain metrics for more complex diagrams. These findings support the conclusion that fine-tuning with LoRA significantly enhances the model's capability for UML-to-code automation. As a result, future development should prioritize LoRA fine-tuning, optimizing batch sizes where possible, and leveraging larger datasets to maximize the potential of UML code generation models.

### Discussion

### Analysis of Results

The work of the present disclosure examined the LLaVA-1.5 model's role in automating UML diagram generation and also explored LLMs for translating visual UML diagrams into code representations. The work evaluated accuracy through BLEU and SSIM scores to evaluate structural fidelity across various datasets and model setups, adding a focus on computational efficiency by analyzing training time, loss, and resource demands for LLaVA-1.5. BLEU and SSIM scores improved as dataset size and model scale increased, particularly with larger LoRA configurations. The enlargement enhances the model's ability to represent complex structures in diagrams.

Evaluating code generation metrics has advanced beyond traditional NLP standards like BLEU, as recent studies underscore their limitations and encourage the development of more specialized metrics for programming contexts. BLEU in this work focused on syntactic rather than semantic similarity. The limitation can be seen in what is considered to be a good BLEU score, where 0.6-1.0 is considered ideal. In the context of code, two pieces of code might render diagrams identically while appearing different on a syntactic level, which is problematic for BLEU. BLEU could penalize such differences, even though such differences do not affect the functional correctness of the code, due to its reliance on n-gram matches.

CodeBLEU addresses several of BLEU's flaws. CodeBLEU refines BLEU by introducing programming-specific features, including AST analysis and data flow tracking. CodeBLEU captures structure-sensitive accuracy for programming, aligning CodeBLEU more closely with functional correctness by balancing traditional n gram matching with AST structure and data flow consistency. Such a method surpasses basic syntactic evaluation, offering a more structural perspective of a program's operation. It was initially trained on traditional programming languages, making it less effective for UML code generation without significant modifications. However, CodeBLEU's effectiveness is not without challenges. Research raises concerns about its alignment with human judgment; while it often outperforms BLEU, it does not consistently reflect human code quality assessments. Human assessment distinction is relevant for generating UML diagrams, where syntax-oriented metrics frequently fail to evaluate visual and structural aspects. For instance, CodeBLEU's reliance on n-gram and AST similarity may inadequately capture output fidelity, as UML diagrams can vary in code but still represent the same visual structure. This work offsets these limitations by incorporating SSIM as an image-to-reference comparison, allowing a closer alignment with human perception of visual accuracy. Using SSIM helps bridge the gap between code-based assessments and UML's preference for precise diagrammatic fidelity and structural representation.

A significant addition to evaluating functional correctness in code generation is the pass@k metric, which has gained traction due to its multi-trial approach. By assessing the correctness of multiple attempts, pass@k better simulates real-world conditions where code generators may take several attempts to produce a functionally correct output. This multi-attempt approach prioritizes functional accuracy over superficial similarity, offering a broader view of model performance.

The rapid evolution of multimodal models has led to notable advancements in processing and interpreting complex visual and textual data. Recent iterations like LLaVA-NeXT, LLaVA-OneVision, mPLUG-Owl3, and Qwen-VL2 showcase substantial enhancements that outshine their predecessors, including LLaVA-1.5. The more advanced models incorporate refined attention mechanisms, larger parameter counts, and enhanced alignment between visual and text inputs, enabling them (i.e., more advanced models) to excel across various tasks, such as multi-image analysis, video processing, and visual question answering. The following sections highlight the unique strengths of each model, focusing on architectural innovations and their importance for complex multimodal understanding.

### LLaVA-NEXT and LLaVA-OneVision

Building on LLaVA-1.5, LLaVA-NeXT leverages advanced language model backbones such as Yi-34 B and can scale to configurations of up to 110 billion parameters, allowing for deeper reasoning and enhanced memory. This model excels in multimodal alignment by embedding advanced OCR capabilities and extensive world knowledge, which make it practical for tasks involving real-world reasoning and scientific diagram interpretation. LLaVA-NeXT's streamlined, resource-efficient design enables high performance in computationally intensive tasks, including high-resolution image analysis and visual reasoning in math-based contexts. Benchmarks such as the MMMU and Math Vista demonstrate LLaVA-NeXT's near state-of-the-art performance. The LLaVA-Bench (Wilder) dataset provides an evaluation framework highlighting the model's strengths in visual reasoning and real-world conversational scenarios. LLaVA-NeXT showcases value in multimodal applications requiring in-depth visual and text-based data comprehension.

Expanding on LLaVA-NeXT, LLaVA-OneVision is optimized for visual tasks like single- and multi-image analysis and video comprehension. With its Higher AnyRes mechanism, the model can adapt to various image resolutions, enhancing its flexibility in image processing. This capability allows LLaVA-OneVision to transfer tasks across visual modalities, a challenge limiting earlier models. One of the defining features of LLaVA-OneVision is its emergent capability in video analysis, allowing zero-shot performance on video-based reasoning tasks for which the model was not explicitly trained. LLaVA-OneVision is suitable for applications that require substantial visual input. In the present case, it allows for use on very complex UML diagrams. The improved LLaVA model addresses a limitation in open-source multimodal models by achieving balanced performance in all visual content.

### Comparative Analysis and Model Selection Implications

The advancements embodied in LLaVA-NEXT and LLaVA-One Vision underscore a clear trajectory toward models capable of handling complex, multi-image, and dynamic visual tasks. While LLaVA-OneVision has cross-modality flexibility, LLaVA-NeXT offers an efficient alternative with advanced reasoning and OCR functionalities. These models also offer promising capabilities for UML code generation from diagrams, addressing limitations observed in prior models. LLaVA-OneVision's handling of high-resolution images and task transfer across modalities enhances the model's ability to capture complicated visual patterns in UML diagrams.

Advancing UML diagram generation relies on improving computational efficiency and expanding dataset diversity, thereby making automated UML models more effective and accessible. This section addresses computational limits and the role of broader training datasets in boosting model performance and adaptability, offering pathways toward robust, versatile MM-LLMs for UML diagram generation. Generating UML diagrams with LLM presents substantial computational demands, particularly as newer multimodal models like LLaVA-OneVision, become more complex. Efficiency-enhancing strategies, such as model distillation, allow smaller models to mimic the output of larger models, preserving knowledge while reducing the model's size and memory constraints. This approach improves inference speed and makes sophisticated LLMs more practical in settings with limited resources.

Another strategy, quantization, reduces model parameter precision to decrease memory usage and improve performance without significantly compromising accuracy. Quantization is beneficial for UML code generation, where selectively applying quantization could streamline visual and textual data processing. These compression methods could expand the usability of large models, making them (i.e., large models) viable in educational and smaller organizational contexts or real-time settings like integrated development environments.

### Dataset Diversity

Dataset diversity is equally important for enhancing the performance and adaptability of UML generation models. Broadening the types of UML diagrams in the training data can help models better handle real-world complexity and avoid overfitting to particular types. Although the present work describes using sequence and activity diagrams, other data sets which integrate structural and behavioral diagrams, such as class diagrams, can be used. Class diagrams, which depict static system aspects such as classes, attributes, and relationships, are central to object-oriented design and widely used in industry. Including class diagrams can improve the model's range. A more holistic dataset could include various types of UML, which would better support tasks requiring extensive diagram parsing and interpretation. Multimodal and domain-specific LLMs trained on diverse datasets generalize better and reduce overfitting. Models trained with broader data perform consistently across different contexts, and this diversity-driven generalization help prevent hallucinations, reduce errors in diagram generation, and boost accuracy.

Diagram flows may include logically connected sequences instead of random or disconnected components. By structuring diagrams around a specific, meaningful theme, such as a shopping experience or the stages of manufacturing a vehicle, the model can better leverage contextual relationships between elements to predict the most likely next step or transition. This targeted approach creates a more intuitive flow of actions and states within the diagram, enabling the model to learn from sequences that align with real-world processes. For example, in a shopping-related activity diagram, terms like ‘customer,’ ‘shopping cart,’ ‘checkout,’ and ‘payment’ are naturally interconnected and follow a logical sequence.

Thematic coherence helps the model recognize probable transitions and behaviors based on context. Rather than treating each element as an isolated unit, the model learns that certain actions, such as ‘selecting items’ leading to ‘adding to cart,’ are more likely to proceed from specific prior states. When trained with these structured, theme-based diagrams, the model gains a stronger understanding of logical progressions within workflows, which enhances its predictive accuracy and contextual relevance. This method is useful in fields where accurate process modeling is preferred, as it enables the model to produce more consistent, coherent diagrams that reflect real-world sequences and interactions.

While LLaVA-1.5 was used in the present work, newer versions such as LLaVA-1.6 and LLaVA-One Vision can be used as well, thereby improving accuracy and multimodal functions, and enhancing UML generation capabilities.

One outcome of the present work is the high structural fidelity and semantic accuracy achieved through fine-tuning with LoRA, as measured by BLEU and SSIM metrics. LoRA fine-tuning significantly outperformed baseline models, reducing syntax errors and improving output quality. Moreover, larger dataset sizes correlated positively with model performance, demonstrating that extensive datasets enhance model accuracy and generalization, particularly with complex diagrams like activity diagrams where baseline models struggled with syntax and type-specific errors. Error analysis further revealed a notable reduction in issues, such as diagram mismatches and UML-type inaccuracies, following fine-tuning. Baseline models frequently defaulted to class diagrams due to ambiguous prompts or task complexity. In contrast, fine-tuned models consistently produced the correct diagram type, underscoring the effectiveness of targeted fine-tuning for enhancing model contextual awareness. These results validate the role of LoRA fine-tuning in automated diagram generation, making it a valuable tool for practical applications in software development.

The present disclosure describes a comprehensive approach to training MM-LLMs for UML diagram-to-code translation. Existing models often need help with the complexities of diverse UML diagrams. This work establishes a dual-metric assessment strategy that captures textual and structural elements by introducing specialized metrics, including BLEU for syntactic accuracy and SSIM for visual fidelity. This approach provides deeper insights into the structural integrity of generated code, which is preferred for applications demanding visual and logical precision. The present disclosure's innovative use of dataset scalability further strengthens model adaptability, demonstrating that more significant, diverse datasets can support model generalization across different diagram types.

This focus on sequence and activity diagrams fills a notable gap in current knowledge (which is primarily centered on simpler class diagrams). The present disclosure expands the capabilities of MM-LLMs for UML code generation. Integrating LoRA fine-tuning adds another layer of innovation, proving both resource-efficient and effective at reducing errors, thus setting a new standard for fine-tuning in this domain. The results achieved in the present disclosure, specifically high BLEU and SSIM scores, establish a new benchmark for MM-LLMs in UML-to-code translation. High BLEU scores reflect close alignment with syntactic expectations, while high SSIM scores confirm fidelity to the visual layout of UML diagrams. These results address a challenge in automated code generation, which is ensuring that machine-generated outputs align with strict structural and syntactic standards.

The success of using BLEU and SSIM as dual evaluation metrics emphasizes the value of assessing both syntactic and visual quality in multimodal outputs. This dual-metric approach could be preferred in fields requiring multimodal synthesis, such as autonomous driving and VR modeling. The broader AI research community might adopt similar composite metrics, enhancing the standards for evaluating multimodal outputs. Ultimately, the present work highlights the potential to reduce human intervention in code generation, demonstrating that MM-LLMs can autonomously generate UML code with minimal oversight, achieving high accuracy and reliability. Automation could streamline software development workflows, allowing engineers to focus on higher-level design rather than manual coding.

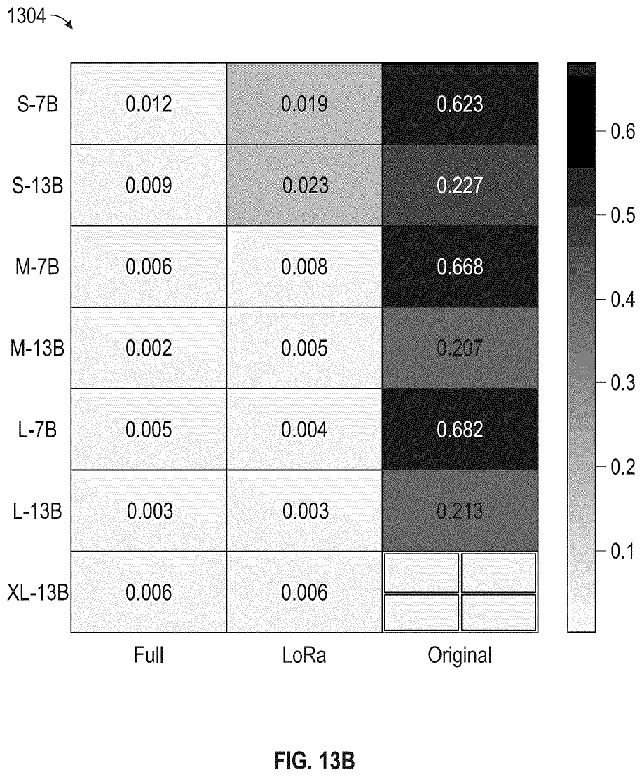

Referring now to FIG. 14, shown therein is an exemplary embodiment of a computer system 1400 (hereinafter, the “system 1400”) constructed in accordance with the present disclosure. In some embodiments, the system 1400 may include, but is not limited to, implementation as a personal computer, a cellular telephone, a smart phone, a network-capable television set, a tablet, a laptop computer, a desktop computer, a network-capable handheld device, a server, a digital video recorder, a wearable network-capable device, a Virtual Reality (VR)/Augmented Reality (AR) device, and/or the like.

As shown in FIG. 14, the system 1400 generally includes one or more input devices 1404a-n (hereinafter, the “input device 1404”), one or more output devices 1408a-n (hereinafter, the “output device 1408”), one or more processors 1412a-n (hereinafter, the “processor 1412”), one or more communication devices 1416a-n (hereinafter, the “communication device 1416”), and one or more memories 1420a-n (hereinafter, the “memory 1420”) storing one or more software applications 1424a-n (hereinafter, the “application 1424”) comprising processor-executable instructions and/or one or more databases 1428a-n (hereinafter, the “database 1428”). The input device 1404, the output device 1408, the processor 1412, the communication device 1416, and the memory 1420 may be connected via a path 1432 such as a data bus that permits communication among the components of the system 1400.

The input device 1404 may be capable of receiving information input from the processor 1412 and/or a user 1436, and transmitting such information to other components of the system 1400 and/or a communication network 1440 using the communication device 1416 as described below. The input device 1404 may include, but is not limited to, implementation as a keyboard, a touchscreen, a mouse, a trackball, a microphone, a camera, a fingerprint reader, an infrared port, an optical port, a cell phone, a smart phone, a Personal Digital Assistant (PDA), a remote control, a fax machine, a wearable communication device, a network interface, combinations thereof, and/or the like, for example.

The output device 1408 may be capable of outputting information in a form perceivable by the processor 1412 and/or the user 1436. The output device 1408 may include, but is not limited to, implementation as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the input device 1404 and the output device 1408 may be implemented as a single device, such as, for example, a touchscreen of a computer, a tablet, or a smartphone. It is to be further understood that as used herein the term “user” (i.e., the user 1436) is not limited to a human being, and may comprise a computer, a server, a website, a processor, a network interface, a user terminal, a virtual computer, combinations thereof, and/or the like, for example. The output device 1408 may display the user interface on the system 1400.

The processor 1412 may include, but is not limited to, implementation as a processor, a microprocessor, a mobile processor, an SoC, a CPU, an MCU, a DSP, an ASIC, an FPGA, a TPU, a GPU, a combination of hardware and software, and/or the like. The processor 1412 may be capable of communicating with the input device 1404, the output device 1408, the communication device 1416, and/or the memory 1420 via the path 1432. The processor 1412 may include one or more of the processor 1412 working together or independently and located locally or remotely (e.g., accessible via the communication network 1440).

The communication device 1416, in communication with the processor 1412, may interface with the communication network 1440. For example, the processor 1412 may be capable of communicating via the communication network 1440 by exchanging signals (e.g., analog, digital, optical, and/or the like) via one or more ports (e.g., physical or virtual ports) using a network protocol to communicate signals and/or data.

The memory 1420 may comprise one or more non-transitory processor-readable media. The memory 1420 may store the application 1424 that, when executed by the processor 1412, causes the system 1400 to perform an action such as communicate with or control one or more component of the system 1400 and/or, via the communication network 1440, a remote system. The memory 1420 may include one or more of the memory 1420 working together or independently to store processor-executable code and may be located locally or remotely (e.g., accessible via the communication network 1440). The application 1424 may include, for example, a web browser capable of accessing a website and/or communicating signals and/or data over a wireless or wired network (e.g., the communication network 1440) and/or the like.

The database 1428 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The database 1428 may be centralized or distributed across multiple systems.

The number of devices and/or networks illustrated in FIG. 14 is provided for explanatory purposes. In practice, there may be additional devices and/or networks, fewer devices and/or networks, different devices and/or networks, or differently arranged devices and/or networks than are shown in FIG. 14. Furthermore, two or more of the components or devices illustrated in FIG. 14 may be implemented within a single component or device, or a single component or device illustrated in FIG. 14 may be implemented as multiple, distributed components or devices. Additionally, or alternatively, one or more of the components or devices of the system 1400 may perform one or more functions described as being performed by another one or more of the components or devices of the system 1400. Components or devices of the system 1400 may interconnect via wired connections, wireless connections, or a combination thereof.

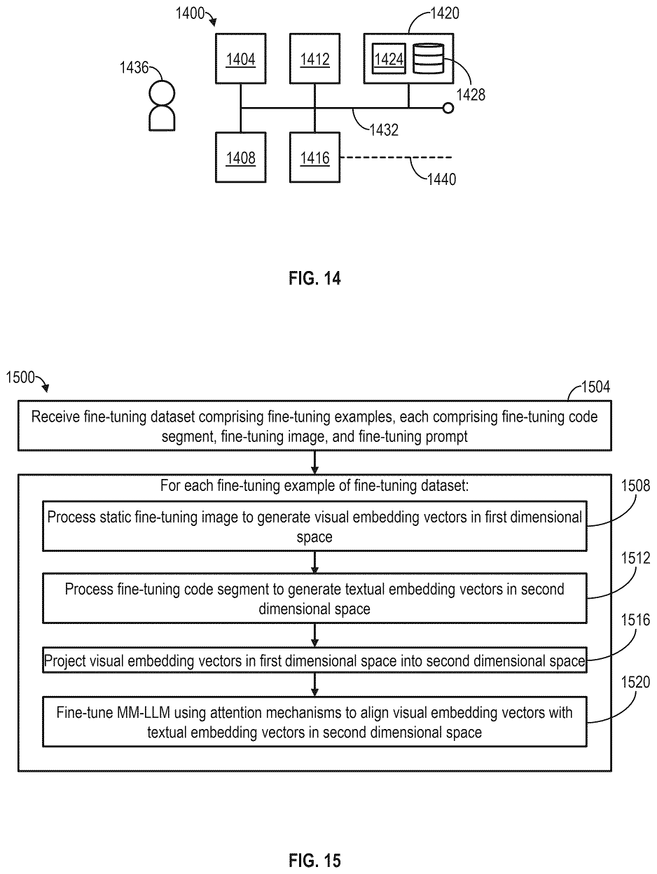

Referring now to FIG. 15, shown therein is an exemplary embodiment of a method 1500 of fine-tuning an MM-LLM (e.g., the MM-LLM 100, the LLaVA model 100a, and/or the LLava-1.5 model 100b) in accordance with the present disclosure. As shown in FIG. 15, the method 1500 generally comprises the steps of: receiving, by a processor 1412, a fine-tuning dataset comprising a plurality of fine-tuning examples, each of the plurality of fine-tuning examples comprising a fine-tuning code segment comprising fine-tuning code conforming to a specification of UML, a static fine-tuning image (e.g., the static input image 120) depicting a fine-tuning diagram having been generated using the fine-tuning code, and a fine-tuning prompt (e.g., the text prompt 124) identifying a fine-tuning diagram type of the fine-tuning diagram (step 1504); and, for each of the plurality of fine-tuning examples of the fine-tuning dataset: processing, by a vision encoder 104, the static fine-tuning image to generate a first plurality of visual embedding vectors 128 representing a plurality of fine-tuning diagram features of the fine-tuning diagram in a first dimensional space (i.e., the vision space) (step 1508); processing, by a language model 112, the fine-tuning code segment to generate a first plurality of textual embedding vectors 136 in a second dimensional space (i.e., the language space) (step 1512); projecting, by a vision-language connector 108, the first plurality of visual embedding vectors 128 in the first dimensional space into the second dimensional space (step 1516); and fine-tuning, by the processor 1412, the MM-LLM 100, 100a, 100b using a plurality of attention mechanisms 148 to align the first plurality of visual embedding vectors 128 in the second dimensional space (i.e., the language-aligned visual embedding vectors 132) and the first plurality of textual embedding vectors 136 in the second dimensional space (step 1520).

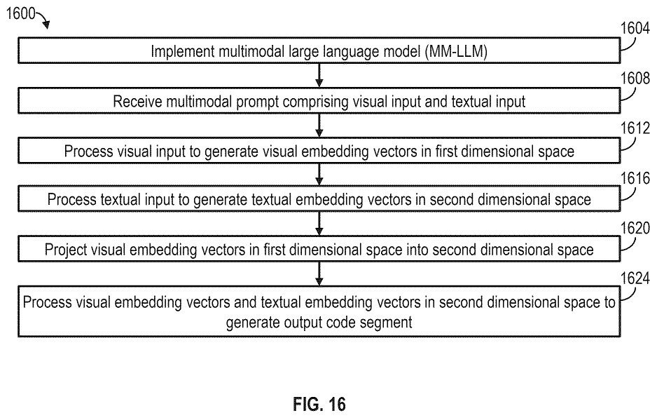

Referring now to FIG. 16, shown therein is an exemplary embodiment of a method 1600 of using an MM-LLM (e.g., the MM-LLM 100, the LLaVA model 100a, and/or the LLava-1.5 model 100b) in accordance with the present disclosure. As shown in FIG. 16, the method 1600 generally comprises the steps of: implementing, by a processor 1412, the MM-LLM 100, 100a, 100b comprising a vision encoder 104, a vision-language connector 108, and a language model 112, the MM-LLM 100, 100a, 100b having been pre-trained using visual instruction tuning to learn alignments between visual data and textual data (step 1604) (i.e., by performing the method 1500 of fine-tuning the MM-LLM 100, 100a, 100b, for example); receiving, by the processor 1412, a multimodal prompt 116 comprising a visual input and a textual input, the visual input comprising a static input image 120 depicting an input diagram having been generated using an input code segment comprising input code conforming to a specification of UML, the textual input comprising a text prompt 124 identifying an input diagram type of the input diagram (step 1608); processing, by the vision encoder 104, the visual input to generate a second plurality of visual embedding vectors 128 representing a plurality of input diagram features of the input diagram in a first dimensional space (step 1612); processing, by the language model 112, the textual input to generate a second plurality of textual embedding vectors 136 in a second dimensional space (step 1616); projecting, by the vision-language connector 108, the second plurality of visual embedding vectors 128 in the first dimensional space into the second dimensional space (step 1620); and processing, by the language model 112, the second plurality of visual embedding vectors 128 in the second dimensional space (i.e., the language-aligned visual embedding vectors 132) and the second plurality of textual embedding vectors 136 in the second dimensional space to generate an output code segment (i.e., the text response 160) comprising output code conforming to the specification of UML, the output code segment when executed by the processor 1412 causing the processor 1412 to generate an output image depicting an output diagram having an output diagram type the same as the input diagram type and at least one of the plurality of input diagram features of the input diagram (step 1624).

In some embodiments, processing the second plurality of visual embedding vectors 128 and the second plurality of textual embedding vectors (step 1624) comprises: identifying, by the language model 112, a syntactic correspondence between one or more of the second plurality of visual embedding vectors 128 and a particular one of a plurality of predefined UML elements; and generating, by the language model 112, a portion of the output code segment (i.e., the text response 160) corresponding to the particular one of the plurality of predefined UML elements.

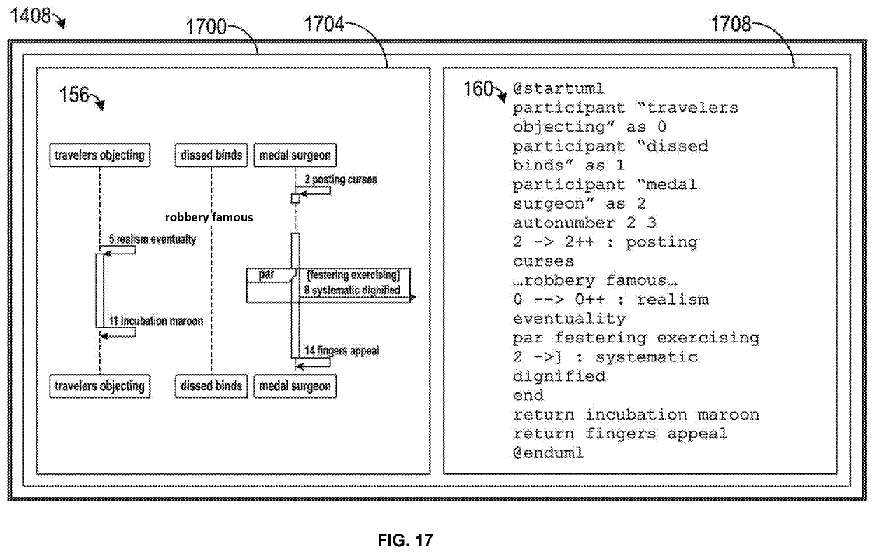

In some embodiments, the method further comprises: executing, by the processor 1412, the output code segment (i.e., the text response 160) to generate the output image 156; and displaying, by the processor 1412, the output code segment and the output image 156 in a user interface 1700 (shown in FIG. 17) on a display (i.e., the output device 1408). The user interface 1700 may be operable to enable editing of the output code segment and, in response to the editing of the output code segment, update the output image 156.

In the embodiment shown in FIG. 17, the user interface 1700 comprises a diagram window 1704 and a code window 1708. The user interface 1700 may be operable to display the text response 160 in the code window 1708 and enable the user 1436 to edit the text response 160 by selecting the text response 160 in the code window 1708 and editing the text response 160 using the input device 1404. Further, the user interface 1700 may be operable to display the output image 156 in the diagram window 1704 and, in response to the user 1436 editing the text response 160 using the input device 1404, update the output image 156 in the diagram window 1704.

In some embodiments, the user interface 1700 may be operable to update the output image 156 in the diagram window 1704 in real-time. That is, the user interface 1700 may be operable to update the output image 156 in the diagram window 1704 without requiring the user 1436 to select a “submit” or “refresh” button after editing the text response 160 using the input device 1404.

In some embodiments, the method 1600 further comprises computing, by the processor 1412, one or more similarity metrics corresponding to a similarity between the output diagram (i.e., the output image 156) and the input diagram (i.e., the static input image 120). The one or more similarity metrics may include at least one of a BLEU score and an SSIM score.

In some embodiments, receiving the multimodal prompt 116 (step 1608) is further defined as receiving, by the processor 1412, the multimodal prompt 116 comprising the visual input (i.e., the static input image 120) and the textual input (i.e., the text prompt 124) identifying the input diagram type of the input diagram, the static input image 120 being one of a raster image, a vector image, and a document-embedded image (e.g., an image embedded in a PDF document).

In some embodiments, receiving the multimodal prompt 116 (step 1608) is further defined as receiving, by the processor 1412, the multimodal prompt 116 comprising the textual input (i.e., the text prompt 124) identifying the input diagram type being one of an activity diagram, a sequence diagram, a class diagram, a use case diagram, a component diagram, and a state machine diagram.

In embodiments in which the MM-LLM 100, 100a, 100b comprises the tokenizer 300, the method 1600 may further comprise tokenizing, by the tokenizer 300, the textual input (i.e., the text prompt 124) to generate a plurality of input tokens (not shown). In such embodiments, processing the textual input (step 1616) may be further defined as processing, by the language model 112, the plurality of input tokens (not shown) to generate the second plurality of textual embedding vectors in the second dimensional space.

In some embodiments, the MM-LLM 100, 100a, 100b may further comprise an error analyzer (not shown). In such embodiments, the method 1600 may further comprise identifying, by the error analyzer (not shown), one or more errors in the text response 160 (i.e., the output code segment). In some such embodiments, identifying the one or more errors may be further defined as identifying, by the error analyzer (not shown), the one or more errors in the text response 160 (i.e., the output code segment), the one or more errors including at least one of a syntactical error, a mismatch between the input diagram type and the output diagram type, and a contextual misinterpretation of a relationship between a first element and a second element in the static input image 120.

### Illustrative Clauses

Exemplary, non-limiting illustrative clauses are provided in the clauses below. However, the scope of the present inventive concept(s) is to be understood to not be limited in any manner by the clauses presented below.

Illustrative clause 1. A system, comprising: a processor; and a non-transitory processor-readable medium storing processor-executable instructions that when executed by the processor cause the processor to implement a multimodal large language model (MM-LLM), the MM-LLM comprising a vision encoder, a vision-language connector, and a language model, the MM-LLM having been pre-trained using visual instruction tuning to learn alignments between visual data and textual data, wherein the processor implementing the MM-LLM is operable to: receive a multimodal prompt comprising a visual input and a textual input, the visual input comprising a static input image depicting an input diagram having been generated using an input code segment comprising input code conforming to a specification of unified modeling language (UML), the textual input identifying an input diagram type of the input diagram; process, by the vision encoder, the visual input to generate a plurality of visual embedding vectors representing a plurality of input diagram features of the input diagram in a first dimensional space; process, by the language model, the textual input to generate a plurality of textual embedding vectors in a second dimensional space; project, by the vision-language connector, the plurality of visual embedding vectors in the first dimensional space into the second dimensional space; and process, by the language model, the plurality of visual embedding vectors and the plurality of textual embedding vectors in the second dimensional space to generate an output code segment comprising output code conforming to the specification of UML, the output code segment when executed by the processor causing the processor to generate an output image depicting an output diagram having an output diagram type the same as the input diagram type and at least one of the plurality of input diagram features of the input diagram.

Illustrative clause 2. The system of illustrative clause 1, wherein the plurality of visual embedding vectors are a first plurality of visual embedding vectors, the plurality of textual embedding vectors are a first plurality of textual embedding vectors, and the MM-LLM has been fine-tuned using a fine-tuning process comprising: receiving a fine-tuning dataset comprising a plurality of fine-tuning examples, each of the plurality of fine-tuning examples comprising a fine-tuning code segment comprising fine-tuning code conforming to a specification of unified modeling language (UML), a static fine-tuning image depicting a fine-tuning diagram having been generated using the fine-tuning code, and a fine-tuning prompt identifying a fine-tuning diagram type of the fine-tuning diagram; and for each of the plurality of fine-tuning examples of the fine-tuning dataset: processing, by the vision encoder, the static fine-tuning image to generate a second plurality of visual embedding vectors representing a plurality of fine-tuning diagram features of the fine-tuning diagram in a first dimensional space; processing, by the language model, the fine-tuning code segment to generate a second plurality of textual embedding vectors in a second dimensional space; and projecting, by the vision-language connector, the second plurality of visual embedding vectors in the first dimensional space into the second dimensional space; and fine-tuning the MM-LLM using a plurality of attention mechanisms to align the second plurality of visual embedding vectors and the second plurality of textual embedding vectors in the second dimensional space.

Illustrative clause 3. The system of illustrative clause 1, wherein processing the plurality of visual embedding vectors and the plurality of textual embedding vectors comprises: identifying, by the language model, a syntactic correspondence between one or more of the plurality of visual embedding vectors and a particular one of a plurality of predefined UML elements; and generating, by the language model, a portion of the output code segment corresponding to the particular one of the plurality of predefined UML elements.

Illustrative clause 4. The system of illustrative clause 1, further comprising a display, wherein the processor implementing the MM-LLM is further operable to: execute the output code segment to generate the output image depicting the output diagram; and display the output code segment and the output image in a user interface on the display, the user interface enabling editing of the output code segment and being operable to update the output image in response to the editing of the output code segment.

Illustrative clause 5. The system of illustrative clause 1, wherein the processor implementing the MM-LLM is further operable to compute one or more similarity metrics corresponding to a similarity between the output diagram and the input diagram.

Illustrative clause 6. The system of illustrative clause 5, wherein the one or more similarity metrics include at least one of a bilingual evaluation understudy (BLEU) and a structural similarity index measure (SSIM).

Illustrative clause 7. The system of illustrative clause 1, wherein the static input image is one of a raster image, a vector image, and a document-embedded image.

Illustrative clause 8. The system of illustrative clause 1, wherein the input diagram type of the input diagram is one of an activity diagram, a sequence diagram, a class diagram, a use case diagram, a component diagram, and a state machine diagram.

Illustrative clause 9. The system of illustrative clause 1, wherein the MM-LLM further comprises a tokenizer, the processor implementing the MM-LLM being further operable to tokenize, by the tokenizer, the textual input to generate a plurality of input tokens, and wherein processing the textual input is further defined as processing, by the language model, the plurality of input tokens to generate the plurality of textual embedding vectors in the second dimensional space.

Illustrative clause 10. The system of illustrative clause 1, wherein the MM-LLM further comprises an error analyzer operable to identify one or more errors in the output code segment.

Illustrative clause 11. The system of illustrative clause 10, wherein the one or more errors include at least one of a syntactical error, a mismatch between the input diagram type and the output diagram type, and a contextual misinterpretation of a relationship between a first element and a second element in the input diagram.

Illustrative clause 12. The system of illustrative clause 1, wherein the MM-LLM is a large language and vision assistant (LLaVA) model.

Illustrative clause 13. The system of illustrative clause 1, wherein the vision encoder is a contrastive language-image pre-training (CLIP) vision encoder.

Illustrative clause 14. The system of illustrative clause 1, wherein the language model is a Vicuna language model.

Illustrative clause 15. The system of illustrative clause 1, wherein the vision-language connector is a linear projection layer.

Illustrative clause 16. The system of illustrative clause 1, wherein the vision-language connector is a multi-layer perceptron (MLP).

Illustrative clause 17. The system of illustrative clause 2, wherein the MM-LLM comprises a plurality of model parameters, the fine-tuning process being a standard fine-tuning process in which each of the plurality of model parameters is updated.

Illustrative clause 18. The system of illustrative clause 17, wherein at least one of the plurality of model parameters is updated based on one or more hyperparameters including at least one of a learning rate hyperparameter, a batch size hyperparameter, and a gradient accumulation hyperparameter.

Illustrative clause 19. The system of illustrative clause 2, wherein the MM-LLM comprises a plurality of model parameters, the fine-tuning process being a low-rank adaptation (LoRA) fine-tuning process in which a subset of the plurality of model parameters is updated.

Illustrative clause 20. The system of illustrative clause 19, wherein at least one of the subset of the plurality of model parameters is updated based on one or more hyperparameters including at least one of a LoRA enablement hyperparameter, a rank hyperparameter, a scaling hyperparameter, a projection learning rate hyperparameter, a learning rate hyperparameter, a batch size hyperparameter, and a gradient accumulation hyperparameter.

Illustrative clause 21. A method, comprising: implementing, by a processor, a multimodal large language model (MM-LLM) comprising a vision encoder, a vision-language connector, and a language model, the MM-LLM having been pre-trained using visual instruction tuning to learn alignments between visual data and textual data; receiving, by the processor, a multimodal prompt comprising a visual input and a textual input, the visual input comprising a static input image depicting an input diagram having been generated using an input code segment comprising input code conforming to a specification of unified modeling language (UML), the textual input identifying an input diagram type of the input diagram; processing, by the vision encoder, the visual input to generate a plurality of visual embedding vectors representing a plurality of input diagram features of the input diagram in a first dimensional space; processing, by the language model, the textual input to generate a plurality of textual embedding vectors in a second dimensional space; projecting, by the vision-language connector, the plurality of visual embedding vectors in the first dimensional space into the second dimensional space; and processing, by the language model, the plurality of visual embedding vectors and the plurality of textual embedding vectors in the second dimensional space to generate an output code segment comprising output code conforming to the specification of UML, the output code segment when executed by the processor causing the processor to generate an output image depicting an output diagram having an output diagram type the same as the input diagram type and at least one of the plurality of input diagram features of the input diagram.

Illustrative clause 22. The method of illustrative clause 21, wherein the plurality of visual embedding vectors are a first plurality of visual embedding vectors, the plurality of textual embedding vectors are a first plurality of textual embedding vectors, and implementing the MM-LLM is further defined as implementing, by the processor, the MM-LLM having been fine-tuned using a fine-tuning process comprising: receiving, by the processor, a fine-tuning dataset comprising a plurality of fine-tuning examples, each of the plurality of fine-tuning examples comprising a fine-tuning code segment comprising fine-tuning code conforming to a specification of unified modeling language (UML), a static fine-tuning image depicting a fine-tuning diagram having been generated using the fine-tuning code, and a fine-tuning prompt identifying a fine-tuning diagram type of the fine-tuning diagram; and for each of the plurality of fine-tuning examples of the fine-tuning dataset: processing, by the vision encoder, the static fine-tuning image to generate a second plurality of visual embedding vectors representing a plurality of fine-tuning diagram features of the fine-tuning diagram in a first dimensional space; processing, by the language model, the fine-tuning code segment to generate a second plurality of textual embedding vectors in a second dimensional space; projecting, by the vision-language connector, the second plurality of visual embedding vectors in the first dimensional space into the second dimensional space; and fine-tuning, by the processor, the MM-LLM using a plurality of attention mechanisms to align the second plurality of visual embedding vectors and second first plurality of textual embedding vectors in the second dimensional space.

Illustrative clause 23. The method of illustrative clause 21, wherein processing the plurality of visual embedding vectors and the plurality of textual embedding vectors comprises: identifying, by the language model, a syntactic correspondence between one or more of the plurality of visual embedding vectors and a particular one of a plurality of predefined UML elements; and generating, by the language model, a portion of the output code segment corresponding to the particular one of the plurality of predefined UML elements.

Illustrative clause 24. The method of illustrative clause 21, wherein the method further comprises: executing, by the processor, the output code segment to generate the output image; and displaying, by the processor, the output code segment and the output image in a user interface on a display, the user interface enabling editing of the output code segment and being operable to update the output image in response to the editing of the output code segment.

Illustrative clause 25. The method of illustrative clause 21, wherein the method further comprises computing, by the processor, one or more similarity metrics corresponding to a similarity between the output diagram and the input diagram.

Illustrative clause 26. The method of illustrative clause 25, wherein computing the one or more similarity metrics is further defined as computing, by the processor, the one or more similarity metrics including at least one of a bilingual evaluation understudy (BLEU) and a structural similarity index measure (SSIM).

Illustrative clause 27. The method of illustrative clause 21, wherein receiving the multimodal prompt is further defined as receiving, by the processor, the multimodal prompt comprising the visual input and the textual input identifying the input diagram type of the input diagram, the static input image being one of a raster image, a vector image, and a document-embedded image.

Illustrative clause 28. The method of illustrative clause 21, wherein receiving the multimodal prompt is further defined as receiving, by the processor, the multimodal prompt comprising the textual input identifying the input diagram type being one of an activity diagram, a sequence diagram, a class diagram, a use case diagram, a component diagram, and a state machine diagram.

Illustrative clause 29. The method of illustrative clause 21, wherein the MM-LLM further comprises a tokenizer, the method further comprising tokenizing, by the tokenizer, the textual input to generate a plurality of input tokens, and wherein processing the textual input is further defined as processing, by the language model, the plurality of input tokens to generate the plurality of textual embedding vectors in the second dimensional space.

Illustrative clause 30. The method of illustrative clause 21, wherein the MM-LLM further comprises an error analyzer, the method further comprising identifying, by the error analyzer, one or more errors in the output code segment.

Illustrative clause 31. The method of illustrative clause 30, wherein identifying the one or more errors is further defined as identifying, by the error analyzer, the one or more errors in the output code segment, the one or more errors including at least one of a syntactical error, a mismatch between the input diagram type and the output diagram type, and a contextual misinterpretation of a relationship between a first element and a second element in the input diagram.

Illustrative clause 32. The method of illustrative clause 21, wherein implementing the MM-LLM is further defined as implementing, by the processor, the MM-LLM, the MM-LLM being a large language and vision assistant (LLaVA) model.

Illustrative clause 33. The method of illustrative clause 21, wherein implementing the MM-LLM is further defined as implementing, by the processor, the MM-LLM comprising the vision encoder, the vision encoder being a contrastive language-image pre-training (CLIP) vision encoder.

Illustrative clause 34. The method of illustrative clause 21, wherein implementing the MM-LLM is further defined as implementing, by the processor, the MM-LLM comprising the language model, the language model being a Vicuna language model.

Illustrative clause 35. The method of illustrative clause 21, wherein implementing the MM-LLM is further defined as implementing, by the processor, the MM-LLM comprising the vision-language connector, the vision-language connector being a linear projection layer.

Illustrative clause 36. The method of illustrative clause 21, wherein implementing the MM-LLM is further defined as implementing, by the processor, the MM-LLM comprising the vision-language connector, the vision-language connector being a multi-layer perceptron (MLP).

Illustrative clause 37. The method of illustrative clause 22, wherein implementing the MM-LLM is further defined as implementing, by the processor, the MM-LLM comprising a plurality of model parameters, the fine-tuning process being a standard fine-tuning process in which each of the plurality of model parameters is updated.

Illustrative clause 38. The method of illustrative clause 37, wherein implementing the MM-LLM is further defined as implementing, by the processor, the MM-LLM comprising the plurality of model parameters, the fine-tuning process being a standard fine-tuning process in which each of the plurality of model parameters is updated, at least one of the plurality of model parameters being updated based on one or more hyperparameters including at least one of a learning rate hyperparameter, a batch size hyperparameter, and a gradient accumulation hyperparameter.

Illustrative clause 39. The method of illustrative clause 22, wherein implementing the MM-LLM is further defined as implementing, by the processor, the MM-LLM comprising a plurality of model parameters, the fine-tuning process being a low-rank adaptation (LoRA) fine-tuning process in which a subset of the plurality of model parameters is updated.

Illustrative clause 40. The method of illustrative clause 39, wherein implementing the MM-LLM is further defined as implementing, by the processor, the MM-LLM comprising the plurality of model parameters, the fine-tuning process being a LoRA fine-tuning process in which the subset of the plurality of model parameters is updated, at least one of the subset of the plurality of model parameters being updated based on one or more hyperparameters including at least one of a LoRA enablement hyperparameter, a rank hyperparameter, a scaling hyperparameter, a projection learning rate hyperparameter, a learning rate hyperparameter, a batch size hyperparameter, and a gradient accumulation hyperparameter.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A system, comprising:
a processor; and
a non-transitory processor-readable medium storing processor-executable instructions that when executed by the processor cause the processor to implement a multimodal large language model (MM-LLM), the MM-LLM comprising a vision encoder, a vision-language connector, and a language model, the MM-LLM having been pre-trained using visual instruction tuning to learn alignments between visual data and textual data, wherein the processor implementing the MM-LLM is operable to:
receive a multimodal prompt comprising a visual input and a textual input, the visual input comprising a static input image depicting an input diagram having been generated using an input code segment comprising input code conforming to a specification of unified modeling language (UML), the textual input identifying an input diagram type of the input diagram;
process, by the vision encoder, the visual input to generate a plurality of visual embedding vectors representing a plurality of input diagram features of the input diagram in a first dimensional space;
process, by the language model, the textual input to generate a plurality of textual embedding vectors in a second dimensional space;
project, by the vision-language connector, the plurality of visual embedding vectors in the first dimensional space into the second dimensional space; and
process, by the language model, the plurality of visual embedding vectors and the plurality of textual embedding vectors in the second dimensional space to generate an output code segment comprising output code conforming to the specification of UML, the output code segment when executed by the processor causing the processor to generate an output image depicting an output diagram having an output diagram type the same as the input diagram type and at least one of the plurality of input diagram features of the input diagram.

2. The system of claim 1, wherein the plurality of visual embedding vectors are a first plurality of visual embedding vectors, the plurality of textual embedding vectors are a first plurality of textual embedding vectors, and the MM-LLM has been fine-tuned using a fine-tuning process comprising:
receiving a fine-tuning dataset comprising a plurality of fine-tuning examples, each of the plurality of fine-tuning examples comprising a fine-tuning code segment comprising fine-tuning code conforming to a specification of unified modeling language (UML), a static fine-tuning image depicting a fine-tuning diagram having been generated using the fine-tuning code, and a fine-tuning prompt identifying a fine-tuning diagram type of the fine-tuning diagram; and
for each of the plurality of fine-tuning examples of the fine-tuning dataset:
processing, by the vision encoder, the static fine-tuning image to generate a second plurality of visual embedding vectors representing a plurality of fine-tuning diagram features of the fine-tuning diagram in a first dimensional space;
processing, by the language model, the fine-tuning code segment to generate a second plurality of textual embedding vectors in a second dimensional space; and
projecting, by the vision-language connector, the second plurality of visual embedding vectors in the first dimensional space into the second dimensional space; and
fine-tuning the MM-LLM using a plurality of attention mechanisms to align the second plurality of visual embedding vectors and the second plurality of textual embedding vectors in the second dimensional space.

3. The system of claim 1, wherein processing the plurality of visual embedding vectors and the plurality of textual embedding vectors comprises:
identifying, by the language model, a syntactic correspondence between one or more of the plurality of visual embedding vectors and a particular one of a plurality of predefined UML elements; and
generating, by the language model, a portion of the output code segment corresponding to the particular one of the plurality of predefined UML elements.

4. The system of claim 1, further comprising a display, wherein the processor implementing the MM-LLM is further operable to:
execute the output code segment to generate the output image depicting the output diagram; and
display the output code segment and the output image in a user interface on the display, the user interface enabling editing of the output code segment and being operable to update the output image in response to the editing of the output code segment.

5. The system of claim 1, wherein the processor implementing the MM-LLM is further operable to compute one or more similarity metrics corresponding to a similarity between the output diagram and the input diagram.

6. The system of claim 5, wherein the one or more similarity metrics include at least one of a bilingual evaluation understudy (BLEU) and a structural similarity index measure (SSIM).

7. The system of claim 1, wherein the static input image is one of a raster image, a vector image, and a document-embedded image.

8. The system of claim 1, wherein the input diagram type of the input diagram is one of an activity diagram, a sequence diagram, a class diagram, a use case diagram, a component diagram, and a state machine diagram.

9. The system of claim 1, wherein the MM-LLM further comprises a tokenizer, the processor implementing the MM-LLM being further operable to tokenize, by the tokenizer, the textual input to generate a plurality of input tokens, and wherein processing the textual input is further defined as processing, by the language model, the plurality of input tokens to generate the plurality of textual embedding vectors in the second dimensional space.

10. The system of claim 1, wherein the MM-LLM further comprises an error analyzer operable to identify one or more errors in the output code segment.

11. The system of claim 10, wherein the one or more errors include at least one of a syntactical error, a mismatch between the input diagram type and the output diagram type, and a contextual misinterpretation of a relationship between a first element and a second element in the input diagram.

12. The system of claim 1, wherein the MM-LLM is a large language and vision assistant (LLaVA) model.

13. The system of claim 1, wherein the vision encoder is a contrastive language-image pre-training (CLIP) vision encoder.

14. The system of claim 1, wherein the language model is a Vicuna language model.

15. The system of claim 1, wherein the vision-language connector is a linear projection layer.

16. The system of claim 1, wherein the vision-language connector is a multi-layer perceptron (MLP).

17. The system of claim 2, wherein the MM-LLM comprises a plurality of model parameters, the fine-tuning process being a standard fine-tuning process in which each of the plurality of model parameters is updated.

18. The system of claim 17, wherein at least one of the plurality of model parameters is updated based on one or more hyperparameters including at least one of a learning rate hyperparameter, a batch size hyperparameter, and a gradient accumulation hyperparameter.

19. The system of claim 2, wherein the MM-LLM comprises a plurality of model parameters, the fine-tuning process being a low-rank adaptation (LoRA) fine-tuning process in which a subset of the plurality of model parameters is updated.

20. The system of claim 19, wherein at least one of the subset of the plurality of model parameters is updated based on one or more hyperparameters including at least one of a LoRA enablement hyperparameter, a rank hyperparameter, a scaling hyperparameter, a projection learning rate hyperparameter, a learning rate hyperparameter, a batch size hyperparameter, and a gradient accumulation hyperparameter.
